(19) United States
(12) Patent Application Publication
(10) Pub. No.: US 2017/0242836 A1
(43) Pub. Date: Aug. 24, 2017

(54) ARCHITECTURE, SYSTEM AND METHOD FOR STORING FILES AND DATA IN ORGANIZED GRID FORMAT

(71) Applicant: Adam Marez, Denver, CO (US)

(72) Inventor: Adam Marez, Denver, CO (US)

(21) Appl. No.: 15/050,454

(22) Filed: Feb. 22, 2016

(51) Int. Cl. G06F 17/24; G06F 17/30; H04L 29/08

(52) U.S. Cl. CPC G06F 17/246; H04L 67/1097; G06F 17/30091; G06F 17/30958; G06F 17/3089

(57) ABSTRACT

Embodiments of architecture, systems, and methods for a user or group to organize and store text, files, and folders via a two-dimensional interface where each item (text, files, and folders) has Column and Row identifiers assigned by a User. Other embodiments may be described and claimed.

### TECHNICAL FIELD

Various embodiments described herein relate generally to organizing and storing data including text, files, and folders, including apparatus, systems, and methods used to organize and store data including text, files, and folders.

### BACKGROUND INFORMATION

Files or folders may be organized in various formats or structures and stored in local or networked storage including cloud storage. Data including text and related American Standard Code for Information Interchange “ASCII” information may also be organized in various formats or structures and stored in local or networked storage including cloud storage including via software applications including word processing, number processing, and database processing software applications.

### BRIEF DESCRIPTION OF THE DRAWINGS

FIG. 1A is a simplified block diagram of multiple files and ASCII text organization and storage architecture with a user device employing a new grid structure according to various embodiments.

FIG. 1B is a simplified block diagram of multiple files and ASCII text organization and storage architecture with a user device employing a grid structure as shown in FIG. 1A with additional entries according to various embodiments.

FIG. 1C is a simplified block diagram of multiple files and ASCII text organization and storage architecture with several user devices employing separate grid structures according to various embodiments.

FIG. 1D is a simplified block diagram of multiple files and ASCII text organization and storage architecture with a user device employing a grid structure formed by merging grid structures shown in FIG. 1C according to various embodiments.

FIG. 1E is a simplified block diagram of multiple files and ASCII text organization and storage architecture with several user devices employing separate grid structures according to various embodiments.

FIG. 1F is a simplified block diagram of multiple files and ASCII text organization and storage architecture with a user device employing a grid structure formed by merging grid structures shown in FIG. 1E according to various embodiments.

FIG. 1G is a simplified block diagram of multiple files and ASCII text organization and storage architecture with several user devices employing separate grid structures according to various embodiments.

FIG. 1H is a simplified block diagram of multiple files and ASCII text organization and storage architecture with a user device employing a grid structure formed by merging grid structures shown in FIG. 1G according to various embodiments.

FIG. 1I is a simplified block diagram of multiple files and ASCII text organization and storage architecture with several user devices employing separate grid structures according to various embodiments.

FIG. 1J is a simplified block diagram of multiple files and ASCII text organization and storage architecture with a user device employing a grid structure formed by merging grid structures shown in FIG. 1I according to various embodiments.

FIG. 1K is a simplified block diagram of multiple files and ASCII text organization and storage architecture with a user device employing a grid structure with non-owner changes requiring owner approval by another user device according to various embodiments.

FIG. 1L is a simplified block diagram of multiple files and ASCII text organization and storage architecture with a user device employing an application to view an exported grid structure according to various embodiments.

FIG. 1M is a simplified block diagram of multiple files and ASCII text organization and storage architecture with a plurality of user devices according to various embodiments.

FIG. 2A is a diagram of communication between a first user device and a clip sheet processing system in a multiple files and ASCII text organization and storage architecture according to various embodiments.

FIG. 2B is a diagram of communication between a first user device, a clip sheet processing system, and cloud storage in a multiple files and ASCII text organization and storage architecture according to various embodiments.

FIG. 2C is a diagram of communication between a first user device, a clip sheet processing system, and cloud storage in a multiple files and ASCII text organization and storage architecture according to various embodiments.

FIG. 2D is a diagram of communication between a first user device, a clip sheet processing system, cloud storage, and an E-mail server in a multiple files and ASCII text organization and storage architecture according to various embodiments.

FIG. 2D is a diagram of communication between a first user device, a clip sheet processing system, and cloud storage in a multiple files and ASCII text organization and storage architecture according to various embodiments.

FIG. 3A is a block diagram of a multiple files and ASCII text organization and storage system with a user device 22A viewing a clip sheet according to various embodiments.

FIG. 3B is a block diagram of a multiple files and ASCII text organization and storage system with a user device 22A viewing an exported clip sheet according to various embodiments.

FIG. 4 is a block diagram of a clip sheet processing system according to various embodiments.

FIG. 5A is a flow diagram illustrating several methods for a clip sheet processing system according to various embodiments.

FIG. 5B is a flow diagram illustrating several methods for a clip sheet processing system according to various embodiments.

FIG. 5C is a flow diagram illustrating several methods for a clip sheet processing system according to various embodiments.

FIG. 5D is a flow diagram illustrating several methods for a clip sheet processing system according to various embodiments.

FIG. 5E is a flow diagram illustrating several methods for a clip sheet processing system according to various embodiments.

FIG. 6A is a block diagram of an article according to various embodiments.

FIG. 6B is a block diagram of an article according to various embodiments.

### DETAILED DESCRIPTION

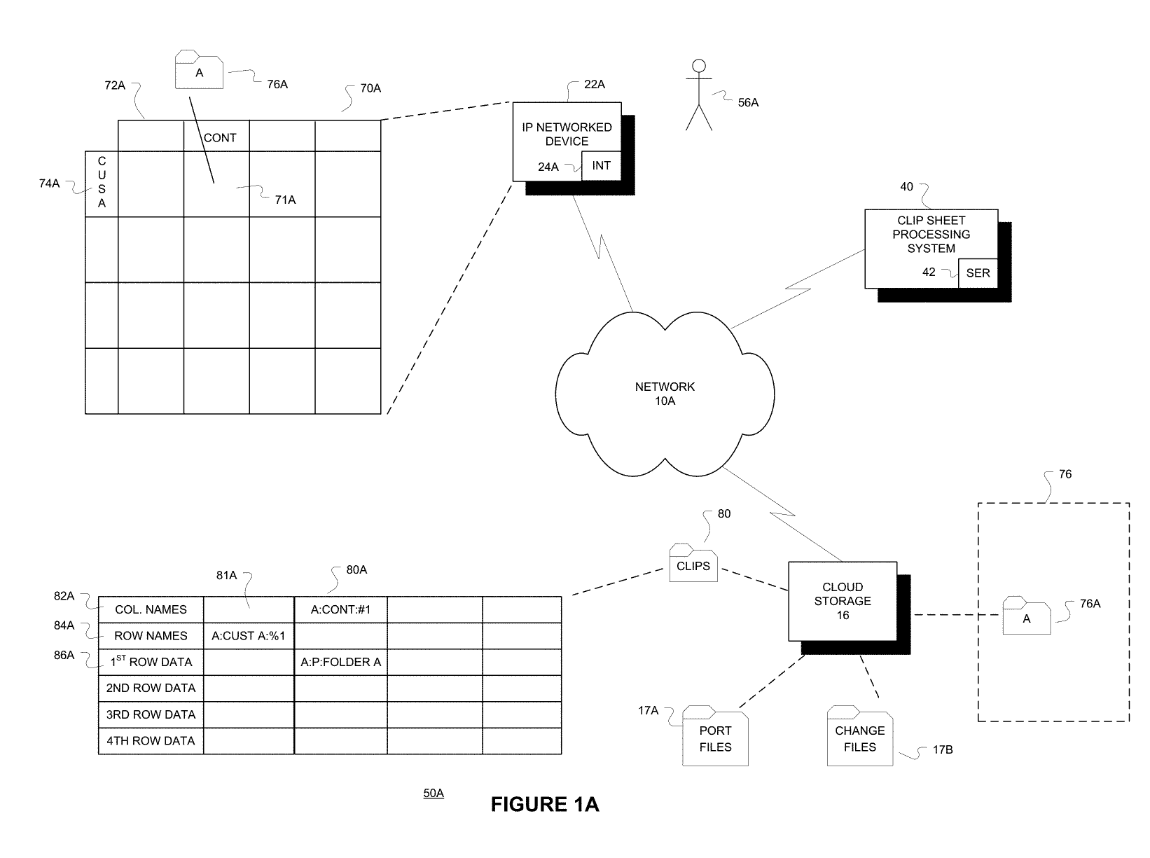

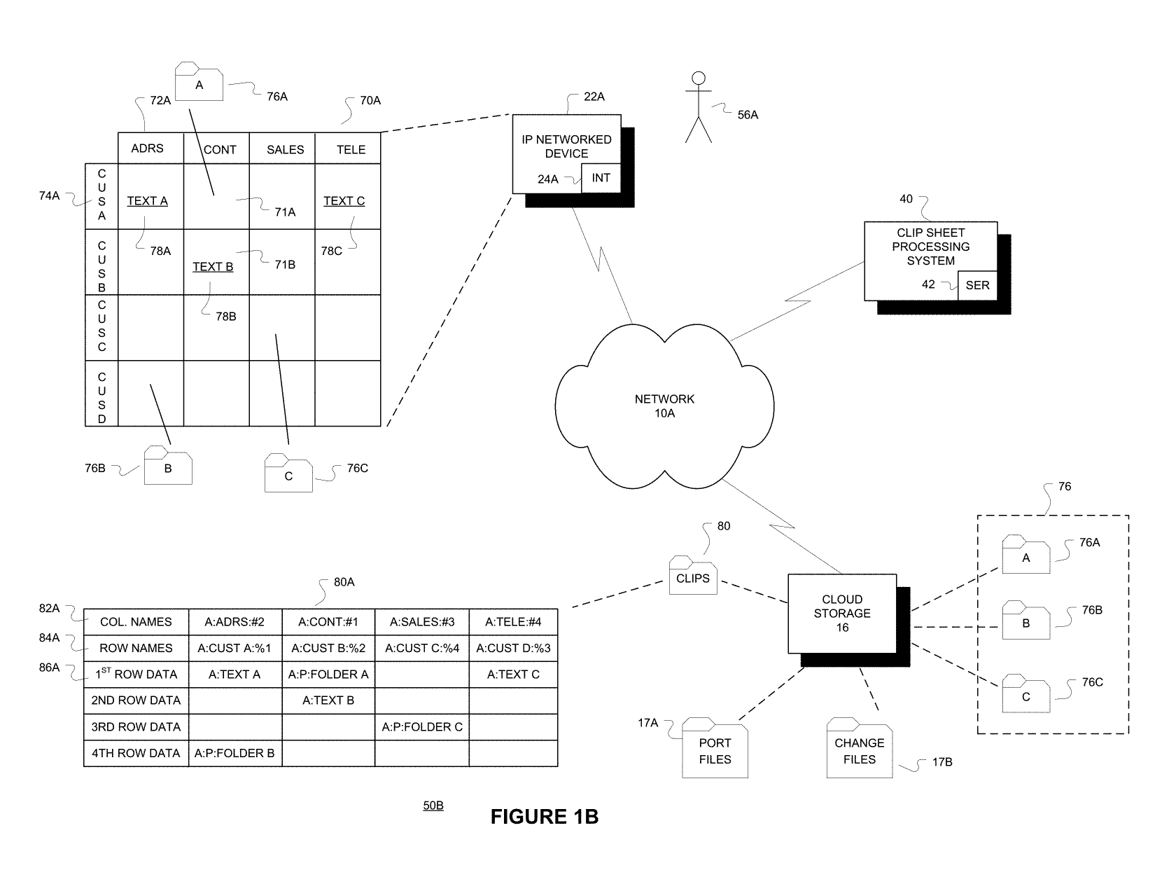

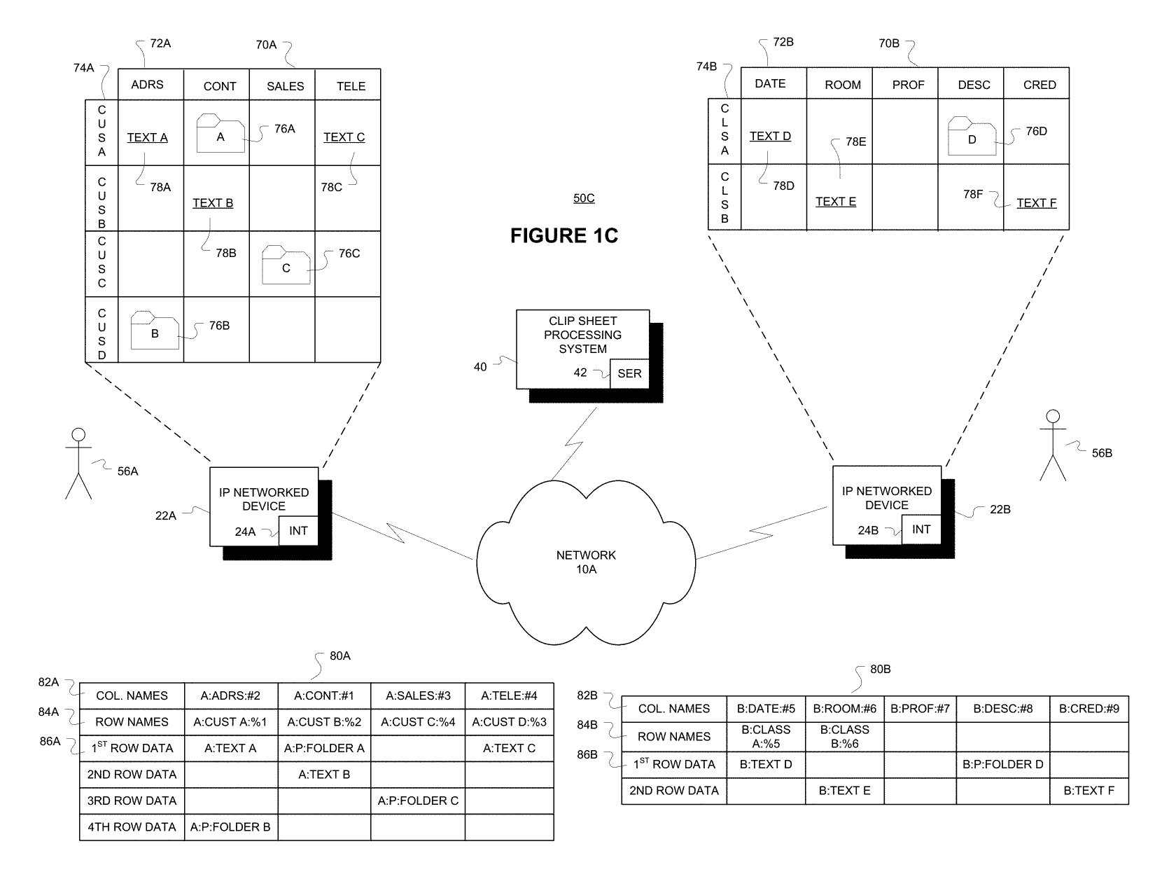

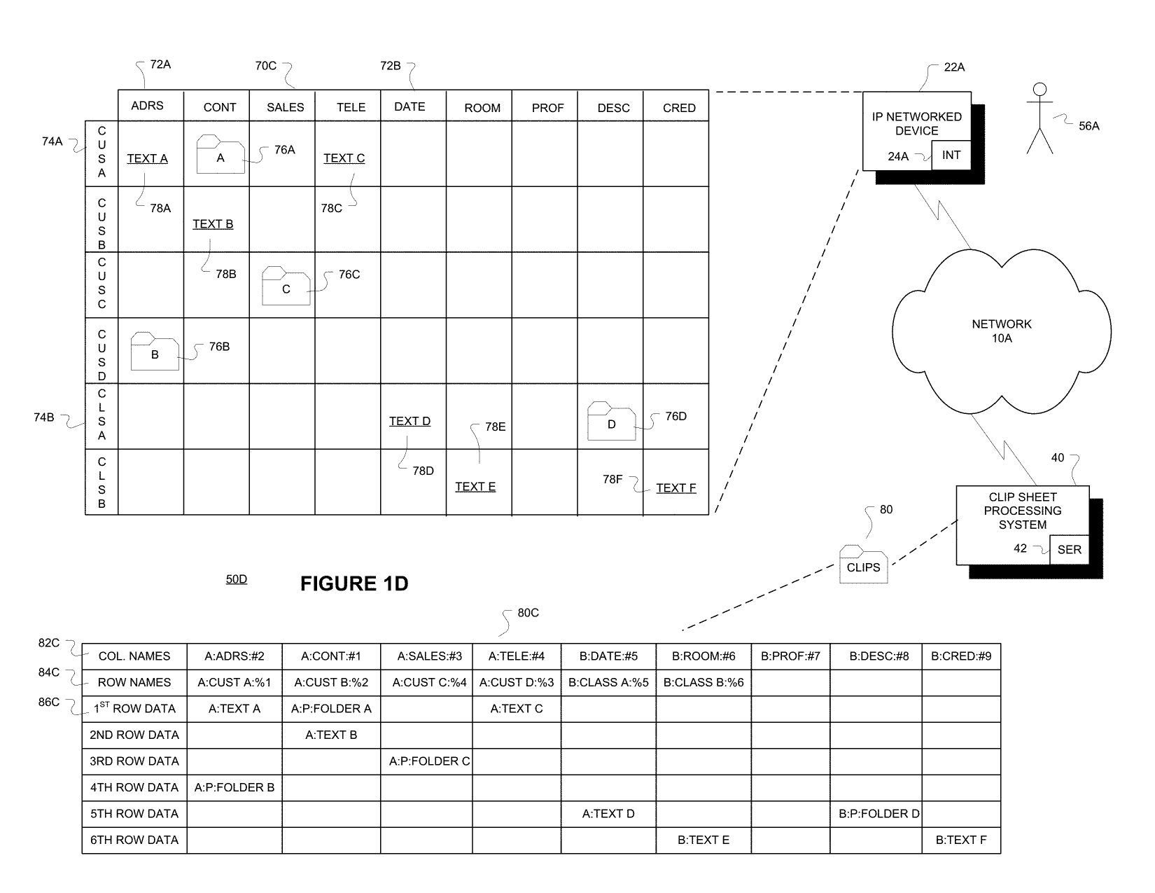

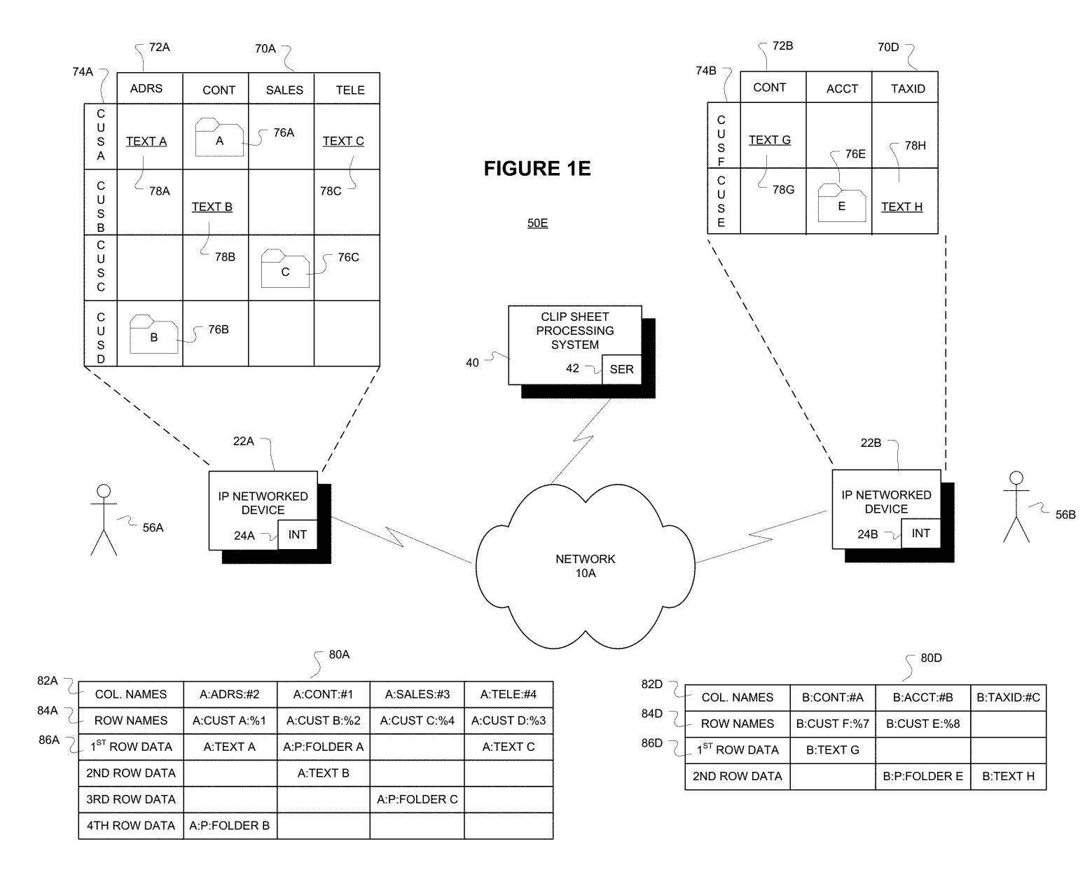

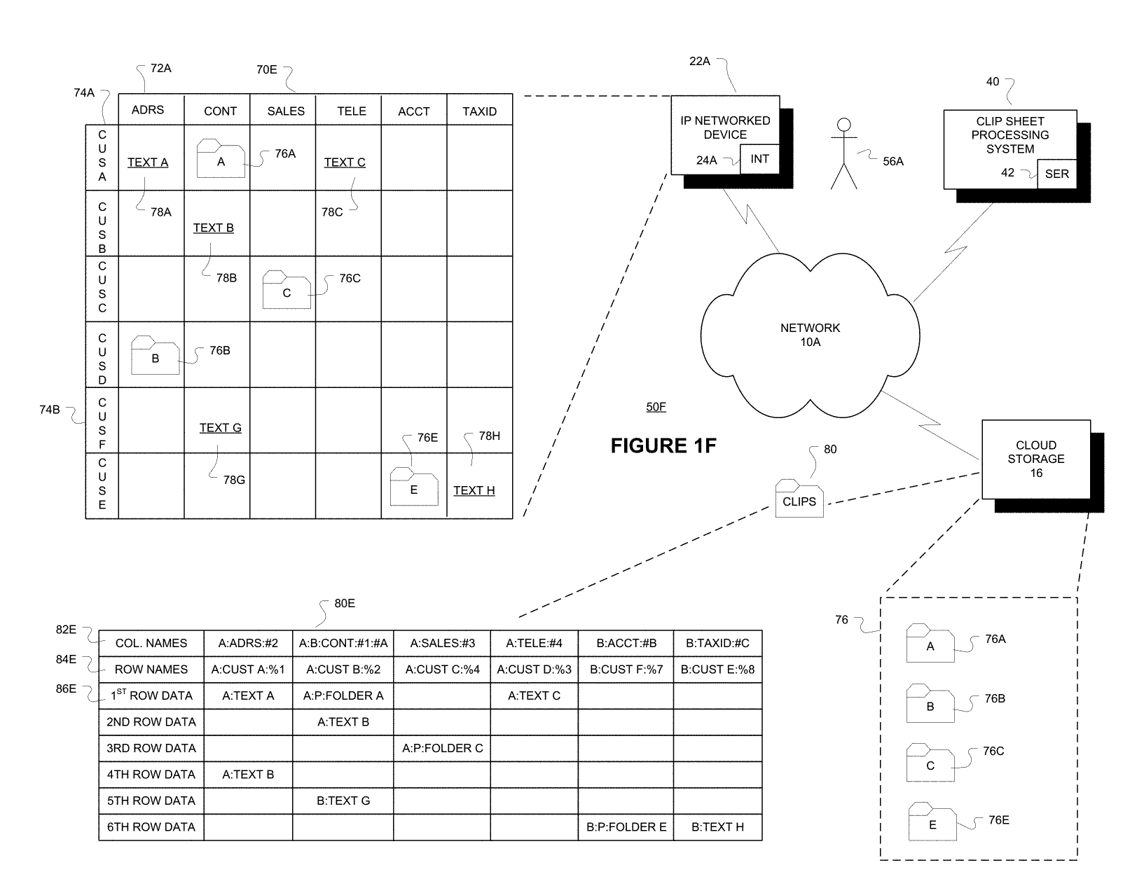

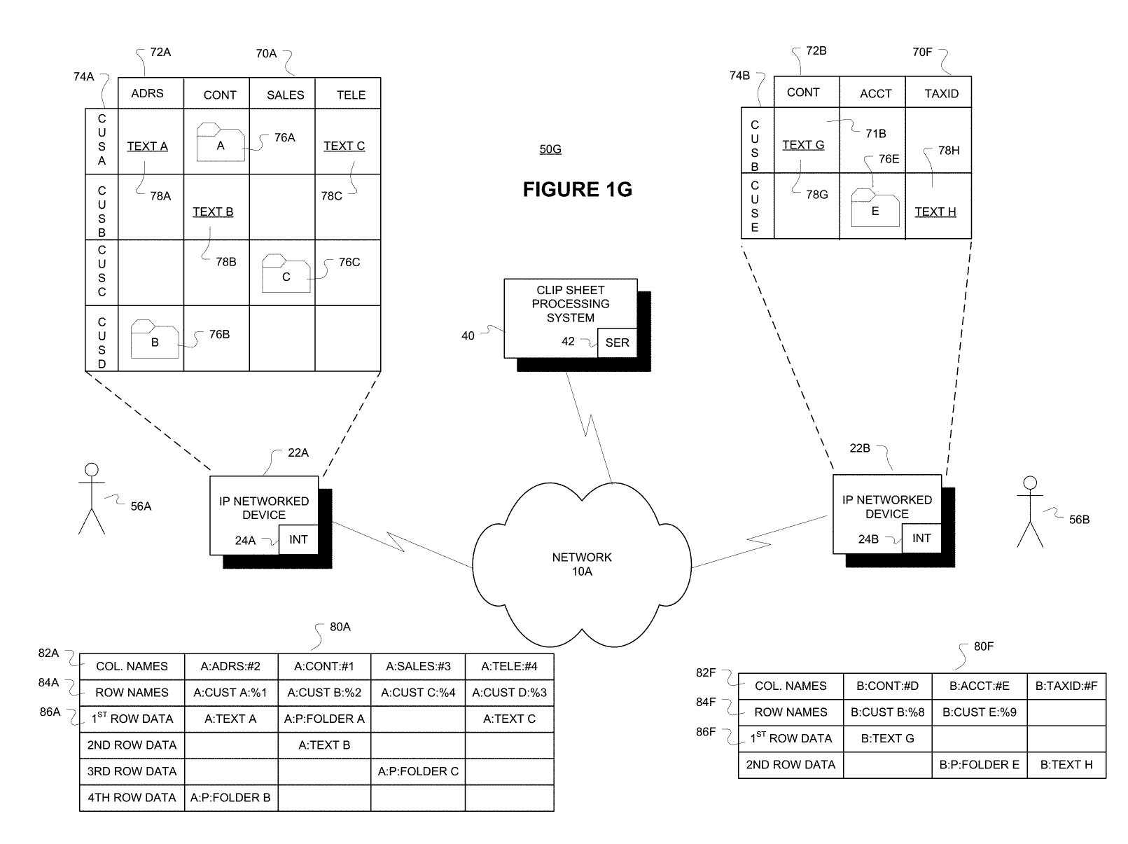

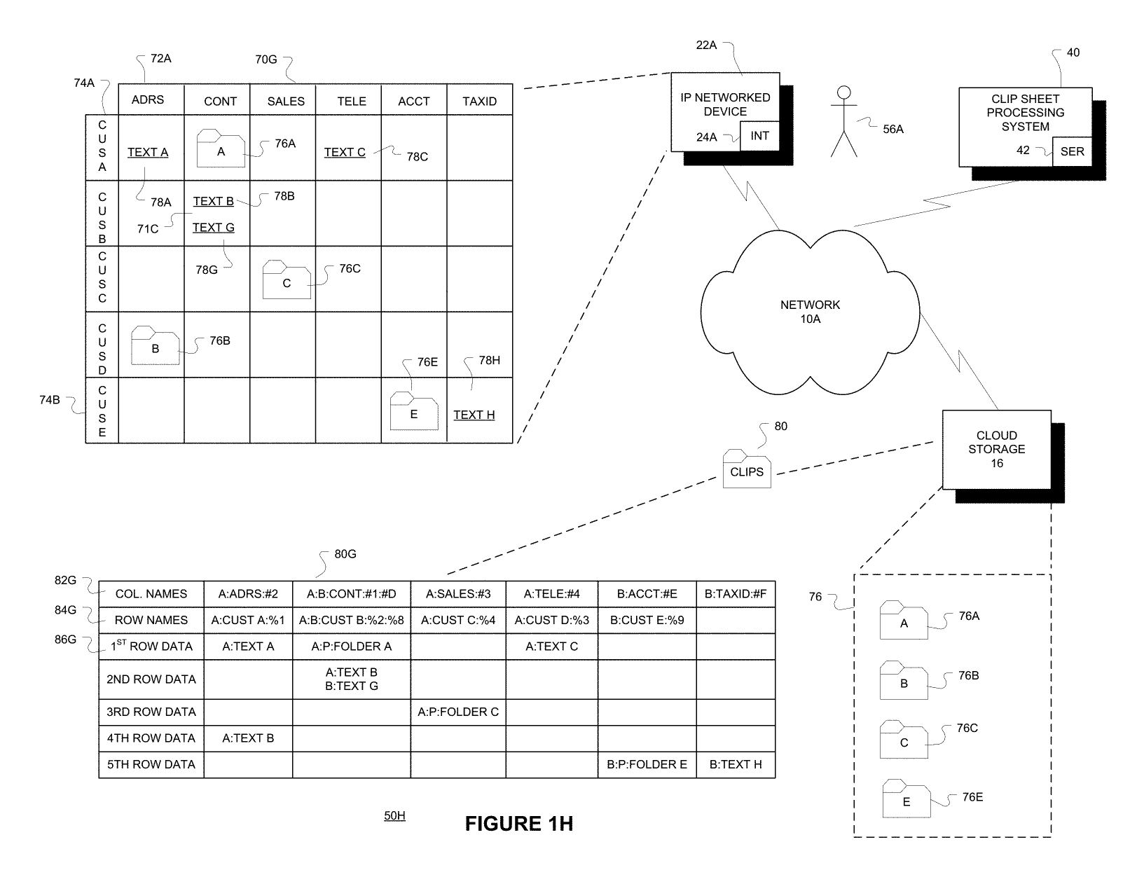

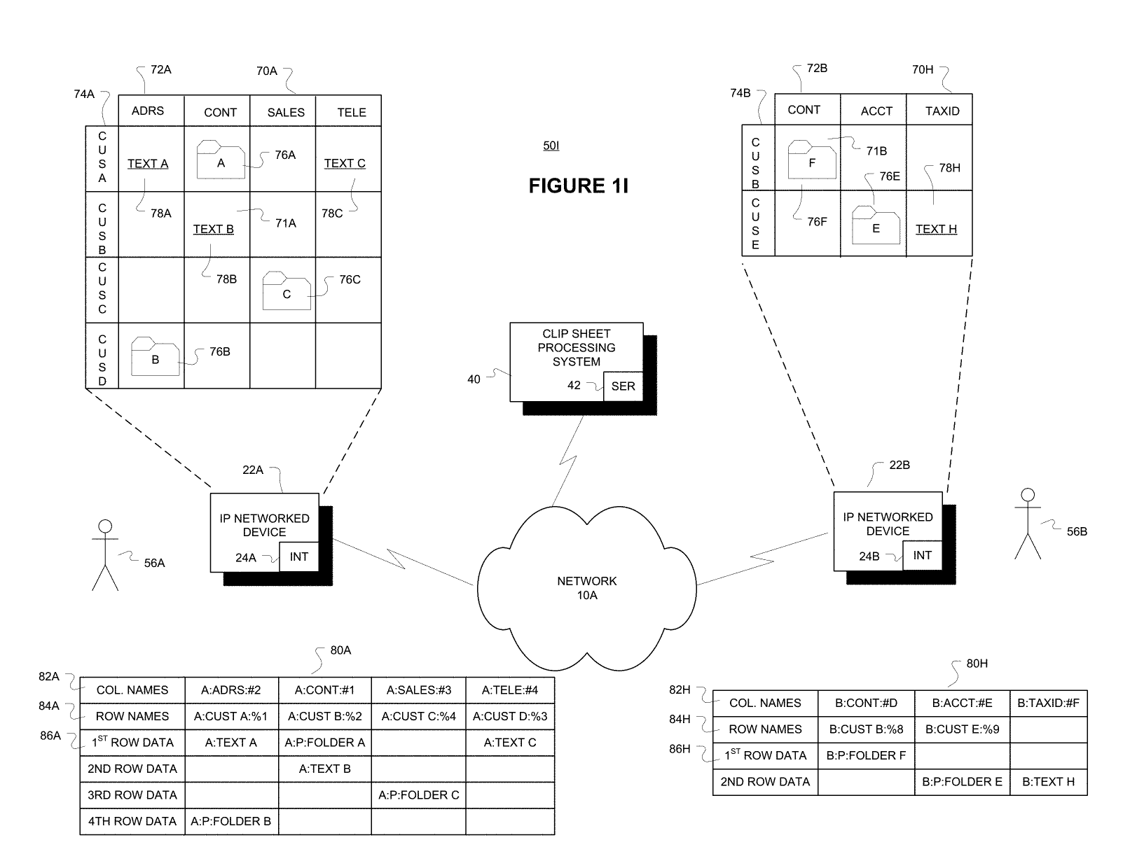

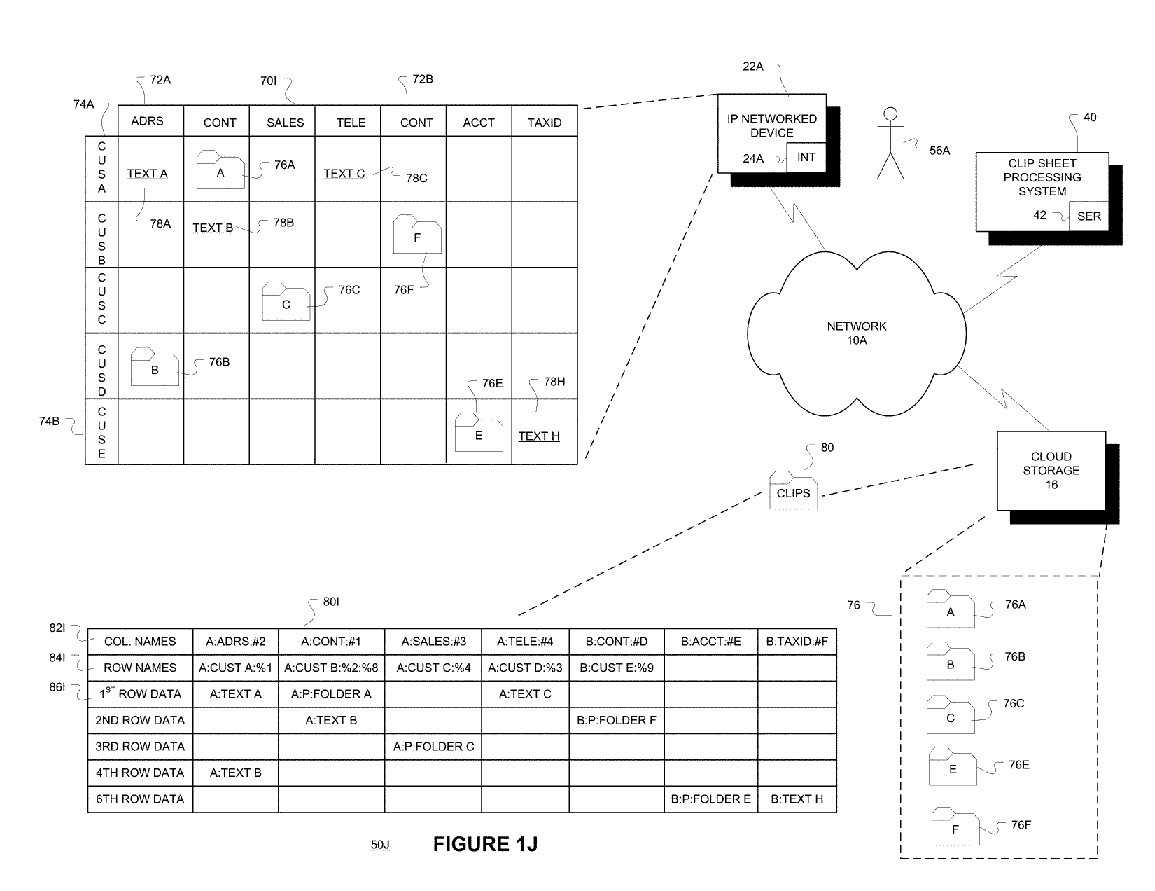

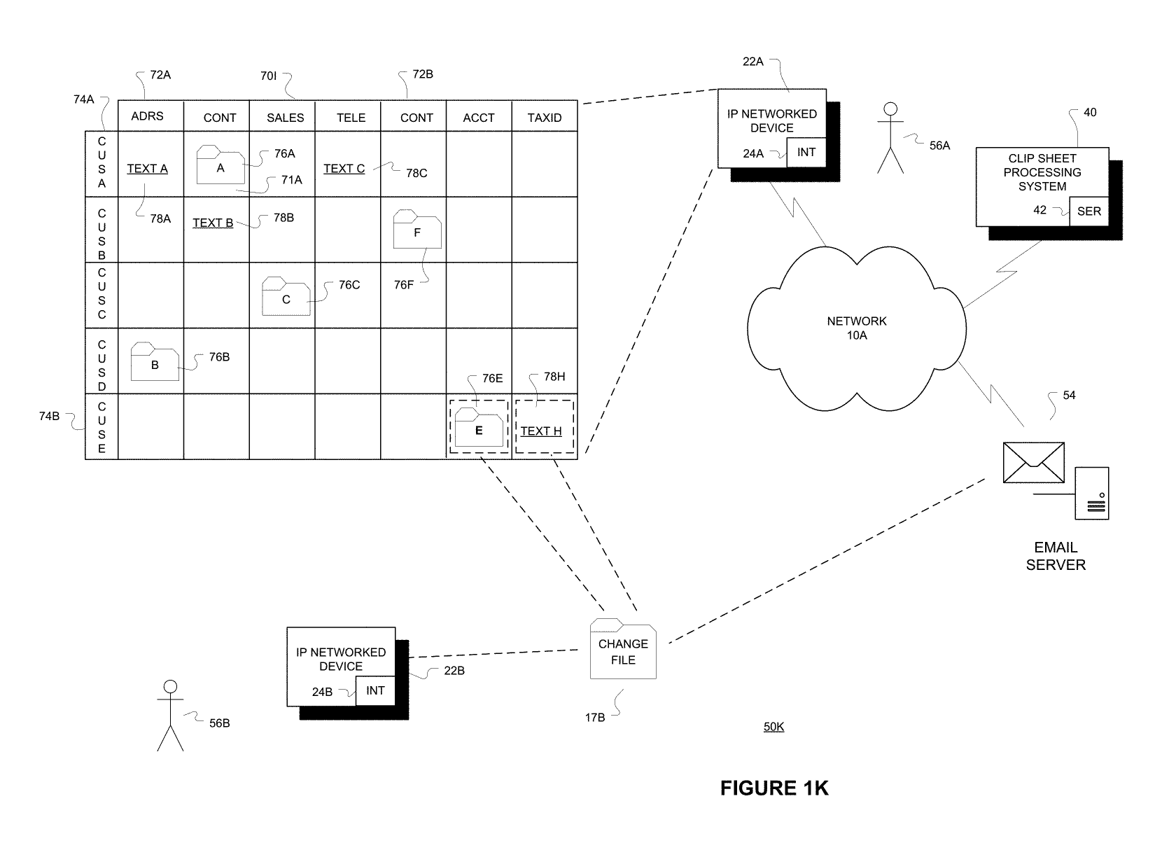

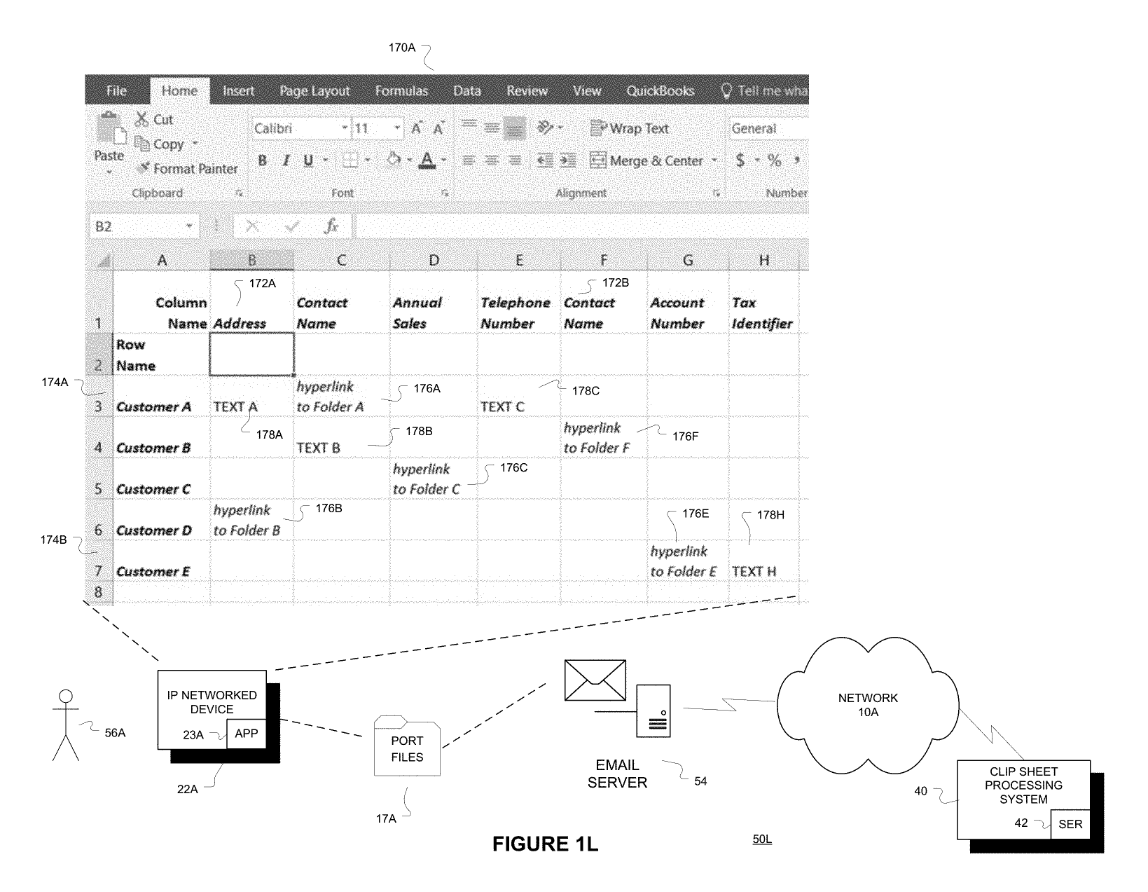

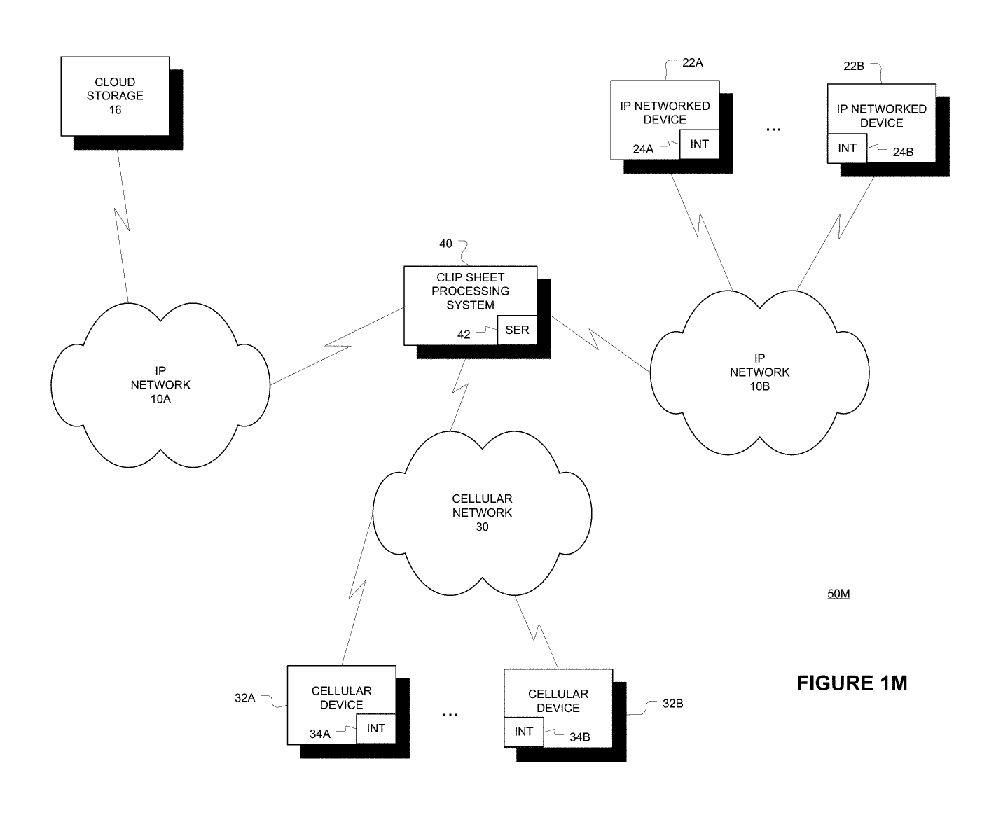

FIG. 1A is a simplified block diagram of multiple files and ASCII text organization and storage architecture 50A with a user's 56A Internet Protocol (IP) network device 22A employing a grid structure 70A according to various embodiments. As shown in FIG. 1A, architecture 50A may include a network 10A, cloud storage system or module 16, IP networked device 22A, and a clip sheet processing system 40. The clip sheet processing system 40 may include a server or network interface 42. The IP networked device 22A may also include a grid or clip sheet module or interface 24A.

It may be desirable to organize and store data including files, folders including a plurality of files, and ASCII text. The present invention employs or provides a two-dimensional (grid) structure or (clip) sheet 70A (via a webpage in one embodiment) to enable a User 56A to organize and store files, folders, and text. In an embodiment, a User 56A may be presented with an empty two dimensional grid or clip sheet 70A after requesting new grid or clip sheet 70A. When a User 56A drags or inserts an item including text, file, or folder 76A into a cell 71A of a row/column of the gird, the User 76A may be directed to provide a first attribute (column name) 72A and a second, orthogonal or non-orthogonal attribute (row name) 74A to be associated with the inserted item 76A.

The first attribute or Column identifier in an embodiment 72A and the second attribute or Row name in an embodiment 74A may enable a User 56A to organize an inserted item 76A (via two, independent attributes). An inserted electronic file or folder 76A may be stored in a directory 76 of a cloud storage system 16. A User 56A may insert another item (text, file, or folder) into the same cell 71A or another cell (different first attribute, different second attribute, or different first and second attribute) based on the relationship with the previously enter item(s). In an embodiment, only like items (files with files, folders with folders, and text with text) may be inserted into the same cell 71A.

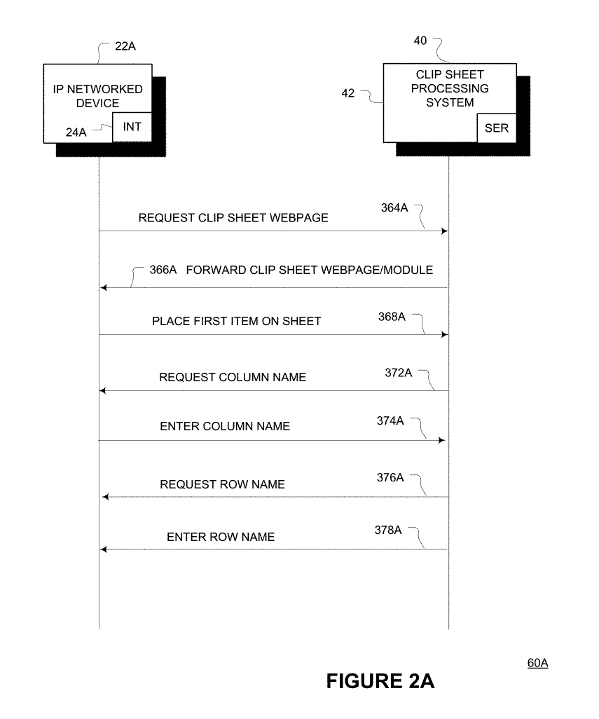

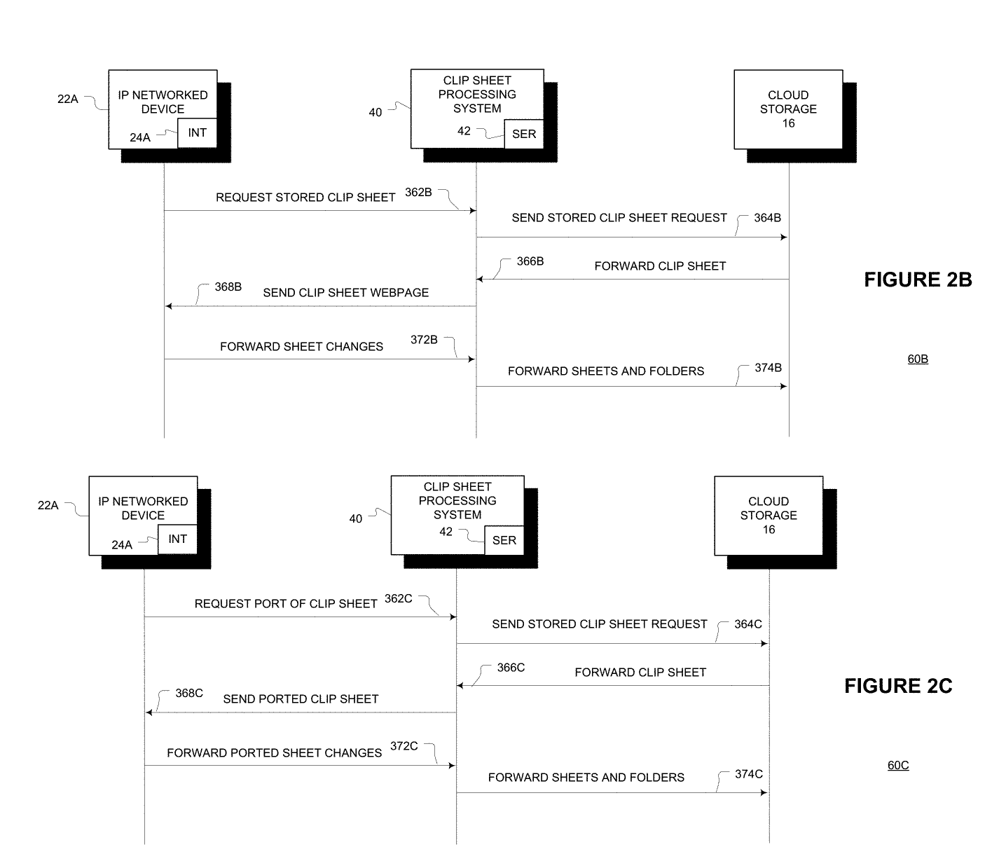

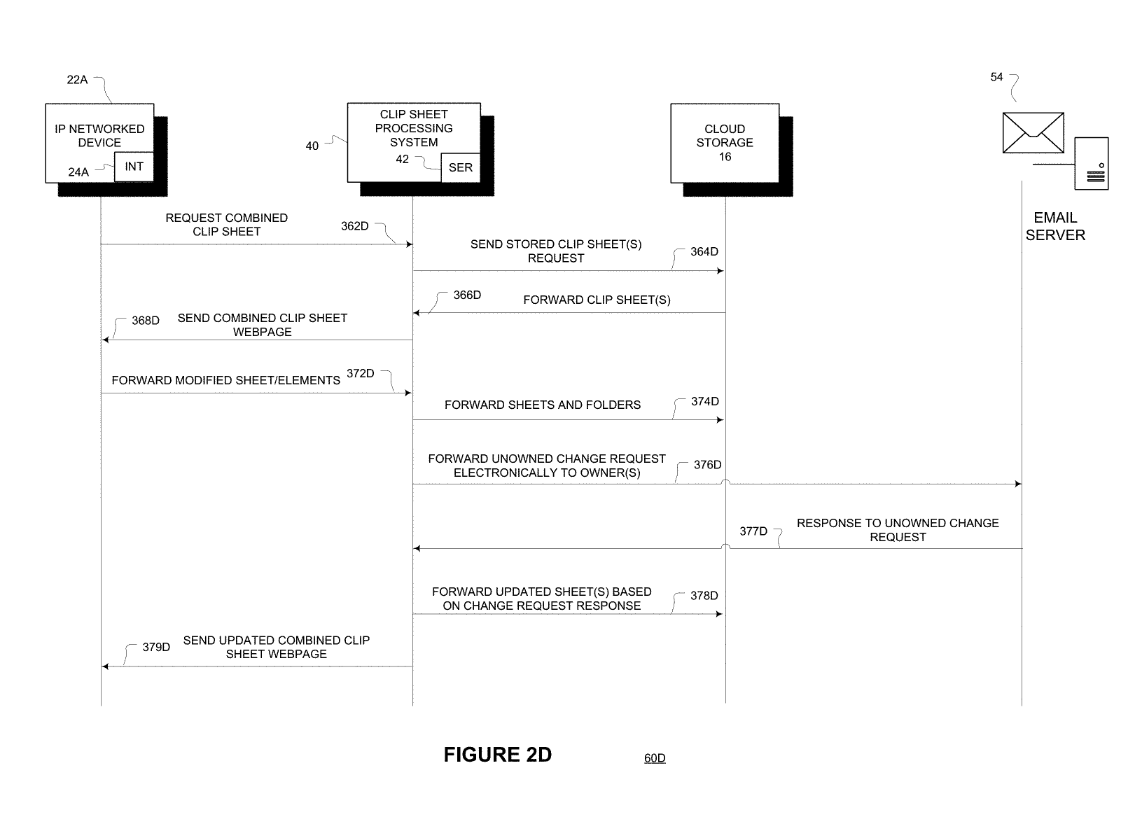

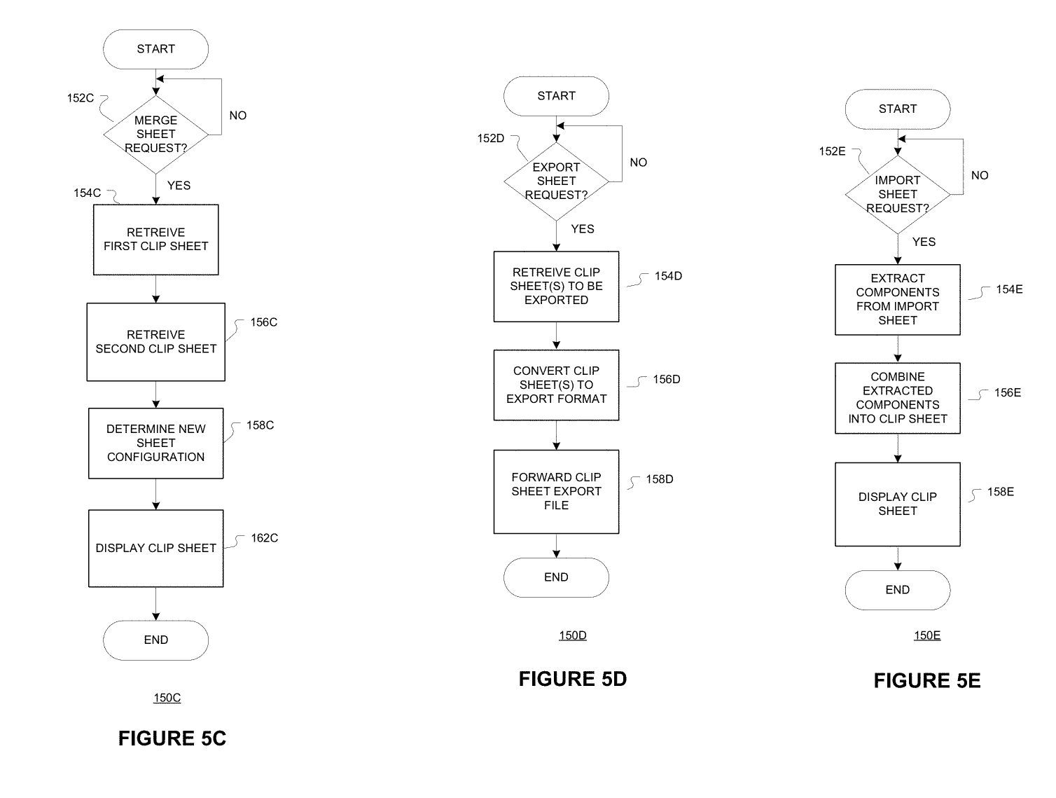

In an embodiment, a two-dimensional grid 70A, termed a clip sheet may be provided to a User 56A from a clip sheet processing system 40 to a User's 56A IP networked device 22A when a User 56A requests a new or pre-existing grid or clip sheet 70A to organize or store files, folders, and ASCII text. The clip sheet processing system 40 may employ an algorithm 150A shown in FIG. 5A and communications 60A between a User 56A IP networked device 22A and a clip processing system 40 shown in FIG. 2A when a User 56A requests a new clip sheet 70A (activity 152A and communication 364A). In an embodiment, the clip sheet processing system 40 via its server 42 may forward a clip sheet webpage, clip sheet module or interface 24A to a User's 56A IP networked device 22A via a Network 10A (activity 154A of FIG. 5A and communication 366A of FIG. 2A).

In one embodiment, a User's 56A identity may be automatically detected via their IP networked device 22A (Machine Address Identifier, IP address, or other device or origin identifier) or via a previous registration stored on their device 22A. When the clip sheet processing system 40 does not determine the User's 56A or their device's 22A identity, the determined User or device is not registered, or the User or system 40 requires login due to inactivity or other security protocol (activity 156A of FIG. 5A), the clip sheet processing system 40 may forward a login or registration page or module to User's 56A device 22A (activity 158A of FIG. 5A). When a User 56A provides a valid login or registration (activity 162A of FIG. 5A), the clip sheet processing system 40 may forward a webpage or enable or activate module 24A (communication 366A) that displays/includes an initial or previously stored/created clip sheet 70A (activity 164A of FIG. 5A).

Once a User 56A via their device 22A enters an item (folder, file or text) into a cell 71A of a sheet 70A (folder A 76A in FIG. 1A, activity 152B of FIG. 5B and communication 368A of FIG. 2A), the clip sheet processing system 40 may store the item (folder 76A) in local storage or in a cloud storage 16 including directory 76 and the sheet 70A in local storage or in a cloud storage 16 including a clip folder 80. The clip processing system 40 may then request a first attribute (column name) 72A to be associated with the inserted item (folder) 76A (activity 154B of FIG. 5B and communication 372A of FIG. 2A). A User 56A may provide a first attribute (column name) 372A to be associated with the inserted item (folder) 76A (communication 374A). The clip processing system 40 may then request a second attribute (row name) 74A to be associated with the inserted item (folder) 76A (activity 156B of FIG. 5B and communication 376A of FIG. 2A). A User 56A may provide a second attribute (row name) 74A to be associated with the inserted item (folder) 76A (communication 378A).

Accordingly, in an embodiment, a User 56A may use a column name 72A to define a first attribute about an inserted item 76A and a row name 74A to define a second attribute about an inserted item 76A. As shown in FIG. 1A, the column name 72A for Folder 76A may represent contact information (CONT short for contact) and the row name 74A may represent a customer name (CUSA short for customer A). Once the first and second attributes (column and row names in an embodiment) have been defined, a clip processing system 40 may update the clip sheet 70A with the defined attributes 72A, 74A and represent the inserted item that includes a folder or file with an icon or other identifier and may further include text related to the folder or file contents or name(s) (activity 158B of FIG. 5B). A text item may be represented by a portion or all of the text as a function of cell size 71A and text font size. The clip processing system 40 may store inserted item(s) and updated clip sheet 70A in local or cloud storage 16 (activity 162B of FIG. 5B).

In an embodiment, the resultant clip sheet 70A may be stored as an electronic data file (such as a clip file in a clip folder 80) by converting the clip sheet 70A data into a file 80A having a predetermined format. As shown in FIG. 1A, a new or initial clip sheet 70A may have a predetermined minimum number of columns and rows (4 each in an embodiment) where the number of columns/rows may be a User 56A setting or system 40 in an embodiment. An electronic file format 80A for a clip sheet 70A according to an embodiment is shown in FIG. 1A. As shown in FIG. 1A, an electronic clip sheet file may include a record 82A for column names where the number of fields is equal to the number of columns (first attributes) in a clip sheet 70A. The file format or configuration 80A may include one or more records 84A for row names (second attributes) where multiple row records 84A may be required when there are more rows (second attributes) in a clip sheet than columns (first attributes). Row names may wrap to next row record in an embodiment to accommodate such a configuration (more 2^{nd} attributes (rows) than 1^{st} attributes (columns). The file format or configuration 80A may also include a record for each 2^{nd} attribute or row 86A in a clip sheet 70A. In a clip sheet electronic file 80A, each row 86A may include the same number of fields 81A as first attributes or columns 72A in a clip sheet 70A. Other clip sheet electronic file 80A formats may be employed in an embodiment. For example, for each second attribute or rows 74A in a clip sheet 70A, its corresponding electronic file 80A may include a corresponding field 81A. Such a file 80A may also include a corresponding record 86A for each first attribute or column 72A of a clip 70A.

In an embodiment, each electronic file 80A field 81A may include a first attribute name 72A, second attribute name 74A, or clip sheet 70A cell 71A entry. As noted in an embodiment, a clip sheet 70A cell 71A may represent or include text 78A, file(s) or folder(s) 76A. In an embodiment, text 78A entries may be stored directly in its corresponding electronic file 80A field 81A. A link to a storage location (file or folder pathway) for each file or folder 76A entry may be stored in its corresponding electronic file 80A field 81A. In an embodiment, each electronic file 80A field 81A may also include an indication of the creator or owner (such as User 56A, 56B) along with the cell 71A entry. As shown in FIG. 1A, the electronic file 80A cell 81A corresponding to folder entry 76A created by User 56A in clip sheet 70A may include ownership information (“A:” of “A:P:FOLDER A” data) and pathway (“P:FOLDER A” of “A:P:FOLDER A” data) to where the folder 76A is electronically stored. The entry “A:” may represent a User 56A and “P:FOLDER A” may represent the electronic pathway to where a folder entry 76A of a clip sheet 70A is stored in a directory 76 of cloud storage 16 in an embodiment.

In an embodiment, each file or folder inserted into a clip sheet 70A cell by a User 56A, 56B may be stored by the clip sheet processing system 40 in local or cloud storage 16. A clip sheet processing system 40 may store each file or folder inserted into a clip sheet 70A cell by a User 56A, 56B into cloud storage 16. The electronic file 80A may store the corresponding link or pathway (P:) to the stored file or folder in a directory 76 of cloud storage 16. In an embodiment, file or folder entries from a clip sheet 70A may be stored in multiple storage systems 16 or a single storage system 16. In a further embodiment, file or folder entries from a clip sheet 70A may be stored in a single storage system 16. In such an embodiment, file or folder entries from a clip sheet 70A may be stored in a single directory 76 of a storage system 16. Additionally, file or folder entries from several clip sheets 70A-I may be stored in a single directory 76 of a storage system 16 due to the electronic file 80A configuration. Accordingly, a clip sheet processing system 40 may be able to process clip sheets 70A-I including many file or folder entries 76A via a simple storage structure.

A clip sheet 70A and its corresponding electronic file 80A may enable a User 56A to organize many files or folders via its first and second attributes 72A, 74A while the files or folders may be stored in a single directory 76. A clip sheet processing system 40 and architecture 50A may enable a User 56A to uniquely manage and store a large number of files or folder via a simple file structure. The clip sheet 70A and its corresponding electronic file 80A via the cell entries 71A, 81A maintain data structure while enabling Users 56A to manage, access, and organize their data (text, files, and folder) via a simple two-dimensional structure. For example, when a User 56A moves a folder entry 76A to any cell 71A of a clip sheet 70A, only the electronic file 80A may be updated while the stored folder location remains constant (in directory 76 of cloud storage 16 in an embodiment).

In an embodiment, a clip sheet processing system 40 may generate unique identifiers for each first attribute identifier 72A, second attribute identifier 74A, and cell 71A entry (including text, file(s), and folder(s)) to be associated with cells 81A of the electronic clip sheet file 80A. Such an embodiment may enable a clip sheet 70A User 56A to use duplicate attribute identifiers 72A, 74A and store duplicate copies of file(s) or folder(s) 76A in various cells 71A of a clip sheet 70A. The unique identifier for each first attribute identifier 72A, second attribute identifier 74A may be stored in the electronic file 80A along with the User identifier.

The electronic clip sheet filed 80A shown in FIG. 1A may include six records 82A, 84A, 86A based on the clip sheet 70A (with an entry for folder item 76A). Each record 82A, 84A, 86A may include four fields for the four columns 72A of the clip sheet 70A (as noted multiple records for clip sheet row identifiers (second attribute) may be required when the clip sheet 70A includes more rows than columns). A first record 82A may include the column (first attribute) identifiers 72A. Each first record 82A field may include a User provided first attribute identifier for the respective column 72A of the clip sheet 70A, a unique identifier, and an owner/user/creator indication. As noted, a clip sheet processing system 40 may also include or add unique identifiers to each first attribute and second attribute. Such unique identifiers may enable User(s) to use identical attributes, folders, or files. As shown in FIG. 1A, the first attributes for the four columns 72A of clip sheet 70A may include “Contact” (abbreviated in FIG. 1A for simplification only). As also shown in FIG. 1A, the first attribute for the four columns 72A of clip sheet 70A may also include an owner/creator/User identifier (“A:” as shown FIG. 1A may be a simplification for such identifier) and a unique identifier (#1), which also may be a simplification for such identifier.

Each second record 84A field may include a User provided second attribute identifier (if any) for the respective row 74A of the clip sheet 70A, a unique identifier, and an owner/user/creator indication. As shown in FIG. 1A, the second attributes for the four rows 74A of clip sheet 70A may include “Customer A” (abbreviated in FIG. 1A for simplification only). As also shown in FIG. 1A, the second attributes (if any) for the four rows 74A of clip sheet 70A may also include an owner/creator/User identifier (“A:” as shown FIG. 80A may be a simplification for such identifier) and a unique identifier (%1), which also may be a simplification for such identifier. The electronic file 80A may also include four data rows 86A with four fields, corresponding to the four rows and four columns, respectively of clip sheet 70A. As shown in FIG. 1A, the first data row 86A, second field may include an entry representing a pathway to the electronic location (cloud storage 16 directory 76 in an embodiment) shown as “P:FOLDER A” and an owner/creator/User indicator shown as “A:” where such indicators may be simplifications in an embodiment.

A corresponding electronic file 80A cell 81A may including unique pathways for various duplicate file(s) or folder(s) entries of a clip sheet file 70A to enable a User 76A to insert multiple or duplicate entries of file(s) or folder(s). In an embodiment, only a single copy of file(s) or folder(s) entered in multiple cells 71A may be stored in a cloud storage 16 directory 76 as a function of clip sheet processing system 40 settings, User device 22A setting, or user settings.

As noted, a clip sheet 70A and its corresponding electronic file 80A may track the Users 56A, 56B that create or modify entries of the clip sheet 70A including the first attribute identifiers 72A, second attribute identifiers 74A, and cells entries 71A (text 78A, files and folders 76A). In an embodiment, each electronic file 80A cell entry 81A may include an indication of ownership (or creator) to protect data or provide/enable permission based changes. As shown in FIG. 1A, a prefix of owner name or other unique owner/user/group/creator identifier may be included with any cell entry 71A or attribute entry 72A, 74A in the corresponding electronic file 80A cell 81A.

In an embodiment, a clip sheet 70A may encoded in various file formats including as part of or embedded in a web page to be displayed by a web browser or application resident on a user device 22A. A clip sheet 70A may also be encoded in a file format specific for other applications or part of an application or interface module 24A forwarded to, previously loaded, or embedded in an IP networked device 24A.

As a User 56A adds items/entries to different cells 71A of a clip sheet 70A, the clip sheet processing system 40 may prompt the User 56A to provide additional first or second attribute identifiers or names 72A, 74A. For example, as shown in FIG. 1B, User 56A has added an entry, TEXT B 78B to the clip sheet 70A cell 71B below the cells 71A. A first attribute identifier 72A may have been previously provided upon entry of an item into cell 71A. A clip sheet processing system 40 may prompt a User 56A for a second attribute identifier to be associated with the cell 71B entry TEXT B 78B. As shown in FIG. 1B, the second attribute identifier to be associated with cell 71B may be Customer B.

Similarly, when a User 56A adds another item to a new cell of a clip sheet 70A such as TEXT A 78A to the clip sheet 70A (right of cell 71A), the clip sheet processing system 40 may prompt the User 56A for a first (cell) attribute identifier 72A to be associated with a new cell entry TEXT A 78A. As shown in FIG. 1B, the first attribute identifier may be “Address”. Similarly, when a User 56A adds Folder B 76B to the clip sheet 70A, the clip sheet processing system 40 may prompt the User 56A for the second attribute (row) name to be associated with the inserted item 76B. As shown in FIG. 1B, the 4^{th} row second attribute identifier 74A may be “Customer D”.

The clip sheet processing system 40 may also prompt the User 56A for the first column (first attribute) name associated with entry 76B (FOLDER B) if it has not already been entered (the entry 78A (TEXT A) has not been added first). Accordingly, when a User 56A enters Folder C 76C into the clip sheet 70A, the clip sheet processing system 40 may prompt the User 56A for both the first attribute identifier 72A (3^{rd} column) and the second attribute identifier 74A (3^{rd} row) name to be associated with the entry 76C. As shown in FIG. 1B, the 3^{rd} column first attribute identifier may be “Sales” and the 3rd row second attribute identifier may be “Customer C”.

Similarly, when a User 56A adds entry 78C (TEXT C) to the clip sheet 70A, the clip sheet processing system 40 may prompt the User 56A for the 4^{th} column (first attribute) identifier associated with the inserted item 78C. As shown in FIG. 1B, the 4^{th} column, first attribute identifier may be “Telephone Number”. The clip sheet processing system 40 may also prompt the User 56A for a 1^{st} row second attribute identifier to be associated with the entry 78C if not already specified/entered. FIG. 1B shows an electronic clip sheet file 80A for clip sheet 70A according to an embodiment.

Similar to the electronic clip sheet filed 80A shown in FIG. 1A, the electronic clip sheet filed 80A shown in FIG. 1B may include six records 82A, 84A, 86A based on the clip sheet 70A. Each record 82A, 84A, 86A may include four fields for the four columns 72A of the clip sheet 70A (as noted multiple second records 84A for clip sheet row identifiers (second attributes) may be required when the clip sheet 70A includes more rows than columns). A first record 82A may include the column (first attribute) identifiers 72A. Each first record 82A field may include a User provided first attribute identifier for the respective column 72A of the clip sheet 70A, a unique identifier, and an owner/user/creator indication. As noted, a clip sheet processing system 40 may also include or add unique identifiers to each first attribute and second attribute.

Such unique identifiers may enable User(s) to use identical attributes, folders, or files. As shown in FIG. 1B, the first attributes for the four columns 72A of clip sheet 70A may include “Address”, “Contact”, “Sales”, and “Telephone” (abbreviated in FIG. 1B for simplification only). As also shown in FIG. 1B, the first attribute for the four columns 72A of clip sheet 70A may also include an owner/creator/User identifier (“A:” as shown FIG. 1B may be a simplification for such identifier) and a unique identifier (#2, #1, #3, and #4 for columns 1 to 4, respectively), which also may be a simplification for such identifier. A clip sheet processing system 40 may assign the unique identifiers as a User 56A provides the attributes 72A, 74A or entries 76A-C and 78A-C.

Each second record 84A field may include a User provided second attribute identifier (if any) for the respective row 74A of the clip sheet 70A, a unique identifier, and an owner/user/creator indication. As shown in FIG. 1B, the second attributes for the four rows 74A of clip sheet 70A may include “Customer A”, “Customer B”, “Customer C”, and “Customer D” (abbreviated in FIG. 1B for simplification only). As also shown in FIG. 1B, the second attribute for the four rows 74A of a clip sheet 70A may also include an owner/creator/User identifier (“A:” as shown FIG. 80A may be a simplification for such identifier) and unique identifiers (%1, %2, %4, and %3 for rows 1-4, respectively), which also may be a simplification for such identifier. The electronic file 80A may also include four data rows 86A with four fields, corresponding to the four rows and four columns, respectively of clip sheet 70A of FIG. 1B. As shown in FIG. 1B, the first data row 86A, first field may include an entry representing User entered textual data (ASCII data in an embodiment) “TEXT A” and an owner/creator/User indicator shown as “A:” where such indicators may be simplifications in an embodiment. The first data row 86A, second field may include an entry representing a pathway to a file(s) or folder(s) in an electronic location (cloud storage 16 directory 76 in an embodiment) shown as “P:FOLDER A” and an owner/creator/User indicator shown as “A:” where such indicators may be simplifications in an embodiment. The first data row 86A, fourth field may include an entry representing other User entered textual data (ASCII data in an embodiment) “TEXT C” and an owner/creator/User indicator shown as “A:”.

As shown in FIG. 1B, the second data row 86A, second field may include an entry representing other User entered textual data (ASCII data in an embodiment) “TEXT B” and an owner/creator/User indicator shown as “A:”. The third data row 86A, third field may include an entry representing a pathway to other file(s) or folder(s) in an electronic location (cloud storage 16 directory 76 in an embodiment) shown as “P:FOLDER C” and an owner/creator/User indicator shown as “A:”. The fourth data row 86A, first field may include an entry representing a pathway to other file(s) or folder(s) in an electronic location (cloud storage 16 directory 76 in an embodiment) shown as “P:FOLDER B” and an owner/creator/User indicator shown as “A:”. As shown in FIG. 1B in an embodiment, a clip sheet processing system 40 may store file and folder entries 76A-76C in a single directory 76 of a cloud storage system 16 and clip electronic file 80A with text items 78A-78C in a clip folder 80 of the cloud storage system 16.

Via a clip sheet processing system 40, a user 56A may be able to process a previously stored clip sheet file 70A by requesting the desired clip sheet 70A via their IP networked device 22A. The communication 60B shown in FIG. 2B may be employed to enable a User 56A to retrieve and update a clip sheet file 70A previously created by the User 56A. As shown in FIG. 2B, a User 56A via an IP networked device 22A may request a stored clip sheet 70A from a clip sheet processing system 40 (communication 362B). The User 56A may request a clip sheet 70A via a web page viewed in a web browser or via a clip sheet application resident on the IP networked device 22A including the clip sheet interface module 24A. In an embodiment, the clip sheet interface module 24A may receive encoded clip sheet data from a clip sheet processing system 40 and generate web pages including clip sheets or clip sheet options including requesting a stored clip sheet 70A.

When the requested clip sheet 70A electronic file 80A is not stored locally, a clip sheet processing system 40 may request the clip sheet electronic file 80A from storage including a cloud storage system 16 (communication 364B). Once the cloud storage system 16 forwards the requested clip sheet electronic file 80A (communication 366), the clip sheet processing system 40 may forward a clip sheet webpage or encoded including the clip sheet 70A to the IP networked device (communication 368B). As noted, the clip sheet interface module 24A may receive encoded clip sheet data from a clip sheet processing system 40 and generate web pages including requested clip sheet(s) or other data that may be displayed a clip sheet 70A via another application resident on or forwarded to a User's 56A device 22A. In an embodiment, the clip sheet interface module 24A may also display a clip sheet 70A and options on a User's device 22A.

A User 56A via their IP networked device 22A may forward an updated clip sheet 70A (or electronic file 80A from a module) to a clip sheet processing system 40 for processing/storage (communication 372B). The clip sheet processing module 40 may convert the clip sheet 70A to an electronic file 80A for storage by a storage system including a cloud storage system 16 (communication 374B). In an embodiment, the clip sheet interface module 24A may forward the clip sheet 70A or clip sheet electronic file 80A to a clip sheet processing system 40. The clip interface module 24A may also forward file(s) or folders(s) entries 76A-C when a User 56A inserts them into a clip sheet 70A 71A cell in an embodiment.

In an embodiment, a clip sheet processing system 40 may enable a first User 56A to merge their clip sheet 70A with another User's 56B clip sheet 70B. A clip sheet processing system 40 may also enable a first User 56A to share their clip sheet 70A with another User's 56B while protecting their entries based on the ownership information and system 40 or User 56A settings. A clip sheet processing system 40 may merge different User's clip sheets 70A and 70B as a function of the related first and second attributes (in columns and rows) if any and the data types in the respective cells 71A, 71B of the clips sheets 70A, 70B to be merged. A clip sheet processing system 40 may employ the algorithm 150C shown in FIG. 5C to process a clip sheet merge request from a User 56A (activity 152C). FIG. 1C is a simplified block diagram of multiple files and ASCII text organization and storage architecture 50C with several user devices 22A, 22B employing/viewing separate grid structures or clip sheets 70A, 70B according to various embodiments. FIG. 1D is a simplified block diagram of multiple files and ASCII text organization and storage architecture 50D with a user device 22A employing a grid structure or clip sheet 70C formed by merging grid structures/clip sheets 70A, 70B shown in FIG. 1C according to various embodiments.

As shown in FIG. 1C, the User's 56A clip sheet 70A is the same as shown in FIGS. 1A and 1B. As also shown in FIG. 1C, a User 56B may have a clip sheet 70B with five columns 72B and two rows 74B. The first attribute identifiers for the five columns 72B may include “Date”, “Room”, “Professor”, “Description”, and “Credits” (abbreviated in FIG. 1C). The second attribute identifiers for the two rows 74B may include “Class A” and “Class B”. The clip sheet 70B may be related to class schedules in an embodiment. As shown in FIG. 1C, the clip sheet 70B may include entries including text entries 78D-F and a folder entry 76D. The text entries denoted as TEXT D 78D, TEXT E 78E, and TEXT F 78F. The folder entry denoted as FOLDER D 76D.

As shown in FIG. 1C, the electronic clip sheet filed 80B shown in FIG. 1C may include four records 82B, 84B, 86B based on the clip sheet 70B according to an embodiment. Each record 82B, 84B, 86B may include five fields for the five columns 72B of the clip sheet 70B. A first record 82B may include the column (first attribute) identifiers 72B. Each first record 82B field may include a User provided first attribute identifier for the respective column 72B of the clip sheet 70B, a unique identifier, and an owner/user/creator indication. As noted, a clip sheet processing system 40 may also include or add unique identifiers to each first attribute and second attribute.

As shown in FIG. 1C, the first attributes for the five columns 72B of clip sheet 70B may include “Date”, “Room”, “Professor”, “Description”, and “Credits” (abbreviated in FIG. 1C). As also shown in FIG. 1C, the first attribute for the five columns 72B of clip sheet 70B may also include an owner/creator/User identifier (“B:” as shown FIG. 1C may be a simplification for such identifier) and a unique identifier (#5, #6, #7, #8, and #9 for columns 1 to 5, respectively), which also may be a simplification for such identifier. A clip sheet processing system 40 may assign the unique identifiers as a User 56A provides the attributes 72B, 74B or entries 76d and 78D-F.

Each second record 84B field may include a User provided second attribute identifier (if any) for the respective row 74B of the clip sheet 70B, a unique identifier, and an owner/user/creator indication. As shown in FIG. 1C, the second attributes for the two rows 74B of clip sheet 70B may include “Class A” and “Class B” (abbreviated in FIG. 1C for simplification). As also shown in FIG. 1C, the second attribute for the two rows 74B of a clip sheet 70B may also include an owner/creator/User identifier (“B:” as shown FIG. 80B may be a simplification for such identifier) and unique identifiers (%5 and %6 for rows 1-2, respectively), which also may be a simplification for such identifier.

The clip sheet 70B corresponding electronic file 80B may also include two data rows 86B with five fields, corresponding to the two rows and five columns, respectively of clip sheet 70B of FIG. 1C. As shown in FIG. 1C, the first data row 86B, first field may include an entry representing User entered textual data (ASCII data in an embodiment) “TEXT D” and an owner/creator/User indicator shown as “B:” where such indicators may be simplifications in an embodiment. The first data row 86A, fourth field may include an entry representing a pathway to a file(s) or folder(s) in an electronic location (cloud storage 16 directory 76 in an embodiment) shown as “P:FOLDER D” and an owner/creator/User indicator shown as “B:” where such indicators may be simplifications in an embodiment. As shown in FIG. 1C, the second data row 86B, second field may include an entry representing other User entered textual data (ASCII data in an embodiment) “TEXT E” and an owner/creator/User indicator shown as “B:”. The second data row 86B, fourth field may include an entry representing other User entered textual data (ASCII data in an embodiment) “TEXT F” and an owner/creator/User indicator shown as “B:”.

A User 56A or User 56B may request to combine their clip sheet 70A or 70B with the others clip sheet 70B and 70A (activity 152C of FIG. 5C). In order to merge clip sheets, a clip sheet processing system 40 may retrieve the clip sheets 70A, 70B to be merged from local or storage (including cloud storage) (activity 154C and 156C of FIG. 5C). In an embodiment, first attributes or second attributes of multiple clip sheets may be merged when they are identical, similar, or never as a function of system 40 settings, User 56A, 56B settings, and attribute settings (activity 158C of FIG. 5C).

In an embodiment, a User 56A, 56B may specific that particular or all first attributes 72A, 72B or second attributes 74A, 74B are merger-able or non-merger-able with other clip sheets. A User 56A, 56B may specific that particular or all first attributes 72A, 72B or second attributes 74A, 74B are merger-able with other clip sheets attributes only when the attributes or identical or have a particular level of correlation. In an embodiment, owners of a clip sheet to be merged may be polled on whether to merge attributes that are identical or highly correlated. In an embodiment, two attributes may be highly correlated when at least 90 percent of their characters' match.

In an embodiment, when one or more first attributes of one sheet are merger-able with first attributes of the second sheet, but no second attributes of the sheets are merger-able, the merged sheet may include all rows (all second attributes of both sheets) and all rows of the second sheet and include one or more aligned columns (due to merger-able first attributes) and the remaining non-merger-able columns (first attributes). Similarly, in an embodiment, when one or more second attributes of one sheet are merger-able with second attributes of the second sheet, but no first attributes of the sheets are merger-able, the merged sheet may include all columns (all first attributes of both sheets) and include one or more aligned rows (due to merger-able second attributes) and the remaining non-merger-able rows (non-merger-able second attributes).

Similarly, in an embodiment, when one or more second attributes of one sheet are merger-able with second attributes of the second sheet and one or more first attributes of the sheets are merger-able, the merged sheet may include merged cells 71A, 71B as a function of the cells entries of each sheet. In an embodiment, merger-able cells (based on first/second attributes and rules/options of system 40 or Users 56A, 56B) may only be merged when they contain the same type of entries (text, file(s), or folder(s). In an embodiment, merger-able cells (based on first/second attributes and rules/options of system 40 or Users 56A, 56B) may be merged regardless of their respective cell entries (text, file(s), or folder(s). In an embodiment, a clip sheet 71A-L may support entry of multiple entry types (text, file(s), folder(s)) in cells 71A, 71B.

As shown in FIG. 1C, clip sheet 70A and clip sheet 70B may not include any identical or substantially similar first attributes 72A, 72B. The clip sheet 70A and clip sheet 70B may not include any identical or substantially similar second attributes 72A, 72B. Clip sheet 70A includes four, first attributes 72A (columns) and four second attributes 74A (rows). Clip sheet 70B includes five, first attributes 72B (columns) and two second attributes 74B (rows). Because clip sheets 70A, 70B do not have any correlated first attributes, a merged clip sheet 70C as shown in FIG. 1D, may include nine first attributes 72C (columns) for the clip sheet's 70A four, first attributes 72A (columns) and clip sheet's 70B five, first attributes 72B (columns). Similarly, because clip sheets 70A, 70B do not have any correlated second attributes, a merged clip sheet 70C as shown in FIG. 1D, may include six second attributes 74C (rows) for the clip sheet's 70A four, second attributes 74A (rows) and clip sheet's 70B two, second attributes 74B (rows).

As shown in FIG. 1D, the four, first attributes (columns) 72A of clip sheet 70A and five, first attributes (columns) 72B of clip sheet 70B may be placed adjacently (activity 162C of FIG. 5C). The four, second attributes (rows) of sheet 70A and the two, second attributes (rows) of sheet 70B may also be placed adjacently. In an embodiment, a user 56A may optionally direct the clip sheet processing system 40 to merge first attributes (columns) or second attributes (rows) even when identifiers do not match or have a minimal correlation.

Similarly, the merged clip sheet 70C electronic clip file 80C may include nine columns and eight rows. The first, five columns of electronic clip file 80C may correspond to the electronic clip file 80A five columns and the last, four columns may correspond to the electronic clip file 80B four columns. The first row 82C of file 80C may include the nine, first attribute identifiers, the first, five, first attribute identifiers from sheet 70A and the second, four, first attribute identifiers from sheet 70B. The second row 84C of file 80C may include the six, second attribute identifiers, the first, four, second attribute identifiers from sheet 70A and the second, two, second attribute identifiers from sheet 70B. The first, four data rows 86C may correspond to the four data rows of electronic file 80A (with final four columns empty) and the final, two data rows may correspond to the two data rows of electronic clip sheet file 80B (with the first, five columns empty).

As shown in FIG. 1D, the electronic file 80C first attributes in row 82C and second attributes 84C may include the same unique identifiers #1 to #9 and %1 to %6 as in the electronic files 80A, 80B. In an embodiment, these attributes (first attributes in row 82C and second attributes 84C) may be assigned new unique identifiers to be associated with the new, merged clip sheet 70C. As discussed above, when at least one first attribute identifier of a first clip sheet is identical (or highly correlated) with at least one first attribute identifier of a second clip sheet, a merger of these sheets may result in less columns than their sum provided merger of the respective attributes is allowed or selected (by the User, owner or system 40).

FIG. 1E is a simplified block diagram of multiple files and ASCII text organization and storage architecture 50E with several user devices 22A, 22B employing/viewing/owning separate grid structures or clip sheets 70A, 70D according to various embodiments. FIG. 1F is a simplified block diagram of multiple files and ASCII text organization and storage architecture 50F with a user device 22A employing a grid structure or clip sheet 70E formed by the clip sheet processing system 40 merging grid structures/clip sheets 70A, 70D shown in FIG. 1E according to various embodiments.

As shown in FIG. 1E, clip sheets 70A and 70D may include an identical first attribute (Contract) (and no matching second attribute). Accordingly, when clip sheets 70A and 70D are merged as shown in FIG. 1F, the resultant clip sheet 70E (and electronic file 80E) may have only six columns with a merged Contract column (first attribute) while the sum of the clip sheet columns is seven (four in sheet 70A and three in sheet 70D). The clip sheets 70A and 70D do not include any identical (or highly correlated) second attributes (rows). Accordingly, the resultant clip sheet 70E may include six rows (and six data rows 86E), the sum of the clip sheets 70A, 70D rows (second attributes). The electronic file 80E may use that same unique identifiers for the attributes in rows 82E and 84E as the source sheets 70A, 70D or assign new unique identifiers in an embodiment.

As shown in FIG. 1E, the User's 56A clip sheet 70A is the same as shown in FIGS. 1A, 1B, and 1C. As also shown in FIG. 1E, a User 56B may have a clip sheet 70E with related customer information (similar to sheet 70A) with three columns (first attributes) 72B Contact, Account Number, and Tax ID (abbreviated in FIG. 1E) and two rows (second attributes) 74B for Customer F and Customer E (abbreviated in FIG. 1E). As shown in FIG. 1E, the clip sheet 70D may include text entries TEXT G 78G and TEXT H 78H and a folder entry FOLDER E 76E. Its corresponding electronic file 80D may include four rows and three columns. One row 82D for the first attribute identifiers 72B Contact, Account Number, and Tax ID and one row 84D for second attribute identifiers 74B Customer F and Customer E. The electronic file 80D may also include data rows 86D for Customer F and Customer E column entries. As shown in FIG. 1E, the electronic file 80D entries may identify the owner or creator of the first and second attribute identifiers, text entries 78G-H and folder entry 76E. The FOLDER E 76E pathway may be stored in electronic file 80D. The electronic file 80D first and second attribute identifiers may also include unique identifiers #A-#C and %7-%8.

As noted the merged, resultant sheet 70E may share a single first attribute “Contact” from both sheets. The resultant clip sheet 70E may include six columns: four (first attributes) columns of sheet 70A, where the Contact attribute is shared with the second sheet 70D and two (first attributes) columns of sheet 70D. The resultant clip sheet 70E may also include six rows: four rows of sheet 70A and two rows of sheet 70D placed consecutively (given no second attribute identifiers are identical or highly correlated).

The corresponding electronic clip file 80E may also include six columns, a first attribute row 82E, a second attribute row 84E, and six data rows 86E. As shown in FIG. 1F, the first attribute row 82E may include six first attributes, three unmerged attributes (Address, Sales, and Telephone) from sheet 70A, two unmerged attributes (Account and Tax ID) from sheet 70D, and one shared/merged attribute (Contact). The first attributes 82E may include owner identifiers and unique identifiers. The merged first attribute may include owner identifiers and unique identifiers from both electronic files 80A, 80D. The second attribute row 84E may include the four, second attributes from sheet 70A, and the two, second attributes from sheet 70D.

The second attributes 84E in electronic file 80E may include owner identifiers and unique identifiers. As noted, the clip sheet processing system 40 may assign new unique identifiers for the first and second attributes 82E, 84E of electronic file 80E. The data rows 86E may include the four rows from clip sheet 70A and two rows from clip sheet 70D. As shown in FIG. 1F, second attribute entries from each sheet 70A, 70D for first attribute Contact are aligned in their respective rows. As also shown in FIG. 1F, the folder entries 76A-C and 76E may be stored in the same directory 76 of a storage system, a cloud storage system 16 in an embodiment.

FIG. 1G is a simplified block diagram of multiple files and ASCII text organization and storage architecture 50G with several user devices 22A, 22B employing separate grid structures or clip sheets 70A, 70F according to various embodiments. FIG. 1H is a simplified block diagram of multiple files and ASCII text organization and storage architecture 50H with a user device 22A employing a grid structure or clip sheet 70G formed by merging grid structures/clip sheets 70A, 70F shown in FIG. 1G according to various embodiments.

As shown in FIG. 1G, the User's 56A clip sheet 70A may be the same as shown in FIGS. 1A, 1B, 1C, and 1E. As also shown in FIG. 1G, a User's 56B clip sheet 70F may include customer information (similar to sheet 70A) with three, first attributes (columns) 72B including Contact, Account Number, and Tax ID and two, second attributes (rows) 74B including Customer B and Customer E. As shown in FIG. 1G, the clip sheet 70F may include several entries 78G, 78H, and 76E in clip sheet cells 71B. The entries may include TEXT G 78G, TEXT H 78H, and FOLDER E 76E.

Its corresponding electronic file 80F may include two attribute rows 82F, 84F and two data rows 86F, each with three fields. The first attribute row 82F may include first attribute identifiers 72B Contact, Account Number, and Tax ID. The second attribute row 84F may include second attribute identifiers 74B Customer B and Customer E. The clip sheet 70F data rows 86F may include cell entries 71B for Customer B and Customer E. As shown in FIG. 1G, the electronic file 80F entries may identify the owner or creator of the attribute identifiers and cell entries 71B. The electronic file 80F entries may also include unique identifiers for the attributes 72B, 74B including #D to #F, %8, and %9.

As shown in FIG. 1G, clip sheets 70A and 70F may include an identical first attribute (Contract) and one identical second attribute Customer B. In addition, the identical first attribute (Contract) and an identical second attribute (Customer B) from both sheets 70A, 70F intersect enabling a cell (71B in FIG. 1H) from both sheets 70A, 70F to be merged as a function of their entry types. Accordingly, when clip sheets 70A and 70F are merged as shown in FIG. 1H, the resultant clip sheet 70G (and electronic file 80G) may have only six columns with a merged Contract column (first attribute) while the sum of the individual clip sheet columns is seven (four in sheet 70A and three in sheet 70F).

As noted, the clip sheets 70A and 70F include one identical second attribute (row) Customer B. Accordingly, the resultant clip sheet 70G may include five rows (and five data rows 86G), the sum of the clip sheets 70A, 70F rows (second attributes) with a merged attribute—Customer B. The electronic file 80G may use that same unique identifiers for the attributes in rows 82G and 84G as the source sheets 70A, 70F corresponding electronic files 80A, 80F or assign new unique identifiers in an embodiment. In particular, the second attribute Customer B merged from both sheets 70A, 70F may include two unique identifiers %2 and %8 from the electronic files 80A, 80F that may be replaced a new, single unique identifier in an embodiment.

As shown in FIG. 1G, sheet 70A and sheet 70F include textual entries at the intersection of first attribute Contact and second attribute Customer B, TEXT B 78B and TEXT G 78G, respectively. Given both sheets 70A, 70F intersecting cell have the same entry type (text), their entries may be merged in the clip sheet 70G. As shown in FIG. 1H, the intersecting cell 71C in merged sheet 70G may include two text entries: TEXT B 78B from sheet 70A and TEXT G 78G from sheet 70F. Similarly, the electronic clip file 80G intersecting field (for 2^{nd} row data 86G and first attribute Contact may include both text entries 78B, 78G.

FIG. 1I is a simplified block diagram of multiple files and ASCII text organization and storage architecture 50I with several user devices 22A, 22B employing separate grid structures or clip sheets 70A, 70H according to various embodiments. FIG. 1J is a simplified block diagram of multiple files and ASCII text organization and storage architecture 50J with a user device 22A employing a grid structure or clip sheet 70I formed by merging grid structures/clip sheets 70A, 70H shown in FIG. 1I according to various embodiments.

As shown in FIG. 1I, the User's 56A clip sheet 70A may be the same as shown in FIGS. 1A, 1B, 1C, and 1E. As also shown in FIG. 1G, the User's 56B clip sheet 70H is similar to clip sheet 70F shown in FIG. 1G except the entry for cell 71B is a folder entry (FOLDER F) 76F versus a text entry (TEXT G 78G in clip sheet 70F). Similar to clip sheets 70A and 70F, clip sheets 70A and 70H also may include an identical first attribute (Contract) and one identical second attribute Customer B. In addition, the identical first attribute (Contract) and an identical second attribute (Customer B) from both sheets 70A, 70H intersect enabling a cell (71B in FIG. 1H) from both sheets 70A, 70F to be potentially merged as a function of their entry types.

As shown in FIG. 1I, the intersecting cell 71A (for first Attribute Contact and second attribute Customer B) in clip sheet 70A is a text entry (TEXT B 78B). The intersecting cell 71B in clip sheet 70H is a folder entry (FOLDER F 76F). In one embodiment, cells 71A, 71B entries are not merged when they include different entry types. The first attribute Contact may not be merged since the corresponding cells 71A, 71B may not be merged. Accordingly, when clip sheets 70A and 70H are merged as shown in FIG. 1I, the resultant clip sheet 70I (and electronic file 80I) may include seven columns with two, different Contract columns (first attribute).

Similarly, the electronic clip file 80I may include seven columns and seven rows. The first attribute row 82I of electronic file 80I may include the seven first attributes identifiers: the first (Address) from sheet 70A, the second (Contact) unmerged from sheet 70A only, the third and fourth (Sales and Telephone Number) from sheet 70A, and the fifth, sixth, and seventh column identifiers (Contact, Account Number and Tax ID) from sheet 70H along with owner identifiers and unique identifiers.

The second attribute row(s) 84I of file 80I may include the second attribute (row) identifiers: the first row identifier (Customer A) from sheet 70A, the second row identifier (Customer B) from both sheets 70A, 70H, the third and fourth row identifiers (Customers C and D) from sheet 70A, and the last row identifier (Customer E) from sheet 70H along with owner identifiers and unique identifiers. The electronic file 80I may include five data rows 86I. The first data row of file 80I may include cell entries for Customer A of sheet 70A. The second data row of file 80I may include cell entries for Customer B from both sheets 70A, 70H. The third and fourth data rows of file 80I may include cell entries from Customers C and D from sheet 70A. The fifth data row of file 80I may include cell entries for Customer E from sheet 70H. As also shown in FIG. 1J, the folder entries 76A-C (from sheet 70A) and 76E-F (from sheet 70H) may also be stored in the same directory 76 of a storage system, a cloud storage system 16 in an embodiment.

In an embodiment, merging a first clip sheet 70A with a second clip sheet 70H may enable Users 56A, 56B to share their clip sheets 70A, 70H as a function of ownership permissions set by the Users 56A, 56B and clip sheet processing system 40. Via the clip sheet processing system 40 or via an exported clip sheet (discussed below), a first User 56A may enable another User 56B to view or modify their clip sheet 70A (without merging into another sheet). The User 56B may be able to save their own version or modify and save the other User's 56A clip sheet via the clip sheet processing system 40 and as a function of the clip sheets 70A viewing and modifications permission set by the User 56A or system 40.

In an embodiment, when a User 56A, 56B changes or attempts to change a clip sheet entry 72A, 74A, 71A not owned by the User, the clip sheet processing system 40 may send a change request file to the owner(s)/creator(s) for their review and approval. In another embodiment, a clip sheet processing system 40 may present the requested changes via clip sheet forwarded to the owner(s). The forwarded clip sheet may highlight the processed changes and enable the owner to approve or dis-approve the proposed changes. As noted below, change may be automatically rejected or accepted/approved if the owner(s) do not review the changes within a predetermined time interval.

The proposed changes may include clip sheet entries including cell entries 71A. The cell entries 71A may include text, file(s), and folder(s) and/or their first or second attributes 72A, 74A. FIG. 1K is a simplified block diagram of multiple files and ASCII text organization and storage architecture 50K with a user device 22A employing a grid structure 70I with proposed/pending non-owner changes requiring owner(s) approval by another user device(s) 22B according to various embodiments. FIG. 2D is a diagram of communications 60D between a first user device 22A, a clip sheet processing system 40, a cloud storage system 16, and an E-mail server 54 in a multiple files and ASCII text organization and storage architecture 1K for combined sheet processing according to various embodiments.

As shown in FIG. 1K, a combined clip sheet processing architecture 1K may include a first User 56A IP networked device 22A processing a combined/merged User clip sheet 70I, a network 10A, a clip sheet processing system 40, an E-mail server 54, and at least one additional User's 56B IP networked device 22B. In an embodiment, a first User 56A via an IP networked device 22A may request a combined User clip sheet 70I for processing (communication 362D of FIG. 2D). In an embodiment, a clip sheet 70I may be a combined clip sheet when the sheet includes at least one item owned/created by a first user and a second item owned/created by a second user. In an embodiment, the clip sheet item may include a Column identifier 72A, a row identifier 74A, or any cell 71A entry including an ASCII text entry 78A, file(s) or folder(s) entry 76A.

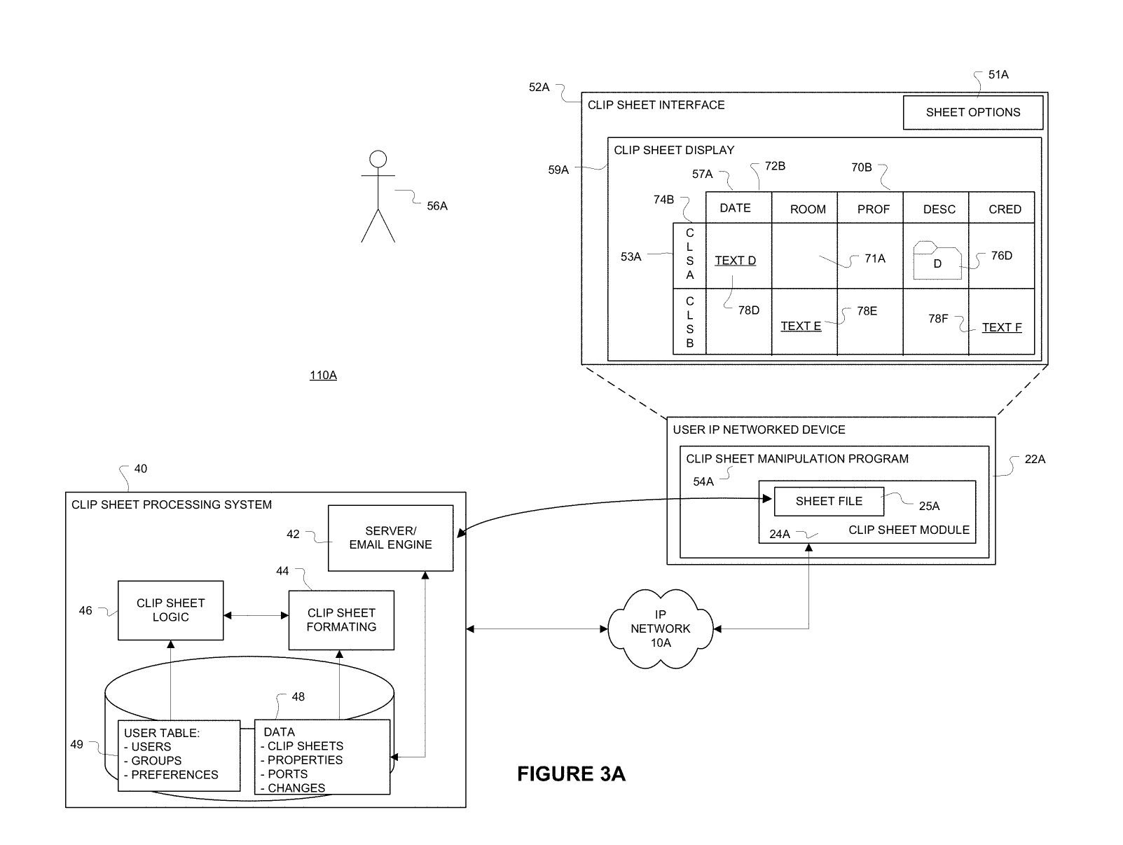

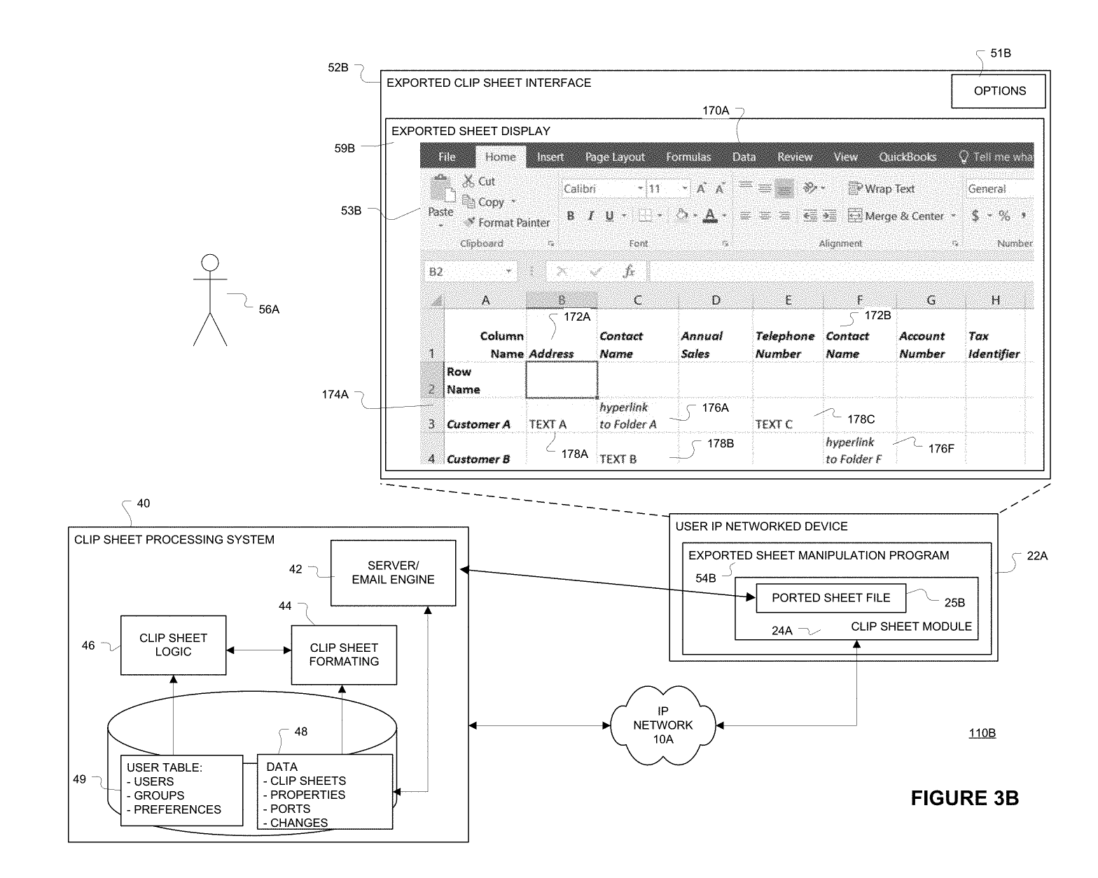

A clip processing system 40 may request the corresponding clip electronic file 80I from a storage system 16 when not stored or cached locally (communication 364D). A storage system including a cloud storage system 16 may forward the requested clip sheet electronic file 80I to a requesting clip sheet processing system 40 (communication 366D). A clip sheet processing system 40 may forward the requested combined clip sheet 70I or electronic file 80I to the IP networked device 22A interface module 24A (communication 368D). As noted in an embodiment, the clip processing system 40 may forward the electronic file 80I for presentation/conversion by the interface module 24A of the IP networked device 22A or a webpage including the formatted clip sheet 70I. The interface module 24A may generate a webpage for display by a web browser or clip sheet interface 52A (FIG. 3A).

Periodically or when a User 56A requests, a IP networked device 22A may forward a modified clip sheet 70I or modified elements (76E, 78H in FIG. 1K) to a clip processing system 40 (communication 372D). As shown in FIG. 1K, a first User, User A (56A) may have changed at least item (76E and 78H) owned or created by a second User B (56B). In an embodiment, a clip sheet processing system 40 may store the related electronic file 80I and requested changes in a storage system 16 (communication 374D) and generate change file(s) 17B including a listing and folder(s) (if any) changes segmented by ownership. In an embodiment, the change file may include the entire clip sheet with modifications highlighted. For example, if User A is attempting to change entrie(s) owned by a User B and other entrie(s) owned by User C, the clip processing system may create a separate change file 17B for User B and User C. The clip processing system 40 may store the pending change requests/files 17B locally or in a storage system 16 (FIG. 1A).

In one embodiment, the clip processing system 40 may forward the change file(s) 17B for review by various, other owners via an E-mail server 54 (communication 376D). In an embodiment, a clip processing system 40 may not implement requested changes 17B until an approval response is received by the respective owner (communication 377D). If a further embodiment, changes 17B may be automatically rejected if the Owner does not provide an approval communication within a predetermined time interval. If another embodiment, change file 17B requested modifications may be automatically approved/applied if the Owner does not provide an approval communication within a predetermined time interval. The automatic rejection or approval of change requests may be configured by each User and the clip processing system 40 in an embodiment.

Once the changes are approved by the User(s) or due to timeout (in one embodiment), the clip processing system 40 may apply the requested changes to the electronic clip sheet file 80I or folders, as applicable and forward them for storage to a storage system (communication 378D). The clip sheet processing system 40 may forward an indication that the changes were approved to the requesting User. If the change file 17B is rejected or times out (in one embodiment), the clip processing system 40 may delete the change file(s) 17B and inform the change requesting User. It is noted that in an embodiment, an owner may be able to approve some changes while rejecting others. In either case (approval of some or all changes or rejection of all changes), the clip processing system 40 may forward an updated clip sheet 70I or electronic clip sheet file 80I with the changes shown to the original change requestor (User A) (communication 379D).

It is noted that the changes (request, approval, or time-out) may occur in real-time (while User 56A is viewing the clip sheet 70I with requested modifications). A User 56A may request non-owned changes to clip sheet items 70I and receive an updated clip sheet 70I reflecting accepted or rejected changes while still viewing the clip sheet 70I (clip sheet 70I interface still active on User's 56A IP networked device 22A). In an embodiment, a clip sheet processing system 40 may lock the items subject to a pending change request in a clip sheet 70I and its related electronic file 80I to prevent other Users other than the requestor from changing the items pending their approval, rejection, automatic approval, or automatic rejection. In an embodiment, a change request forwarded to an owner may include the change file 17B (including electronic file 80I) as an attachment. When the owner approves one or more suggested changes, the clip sheet processing system 40 may receive the change file 17B in addition to the Users response. In such an embodiment, the clip sheet processing system 40 may modify the clip sheet 70I via an approved change file 71B returned by an owner.

In an embodiment, a clip sheet processing system 40 may convert (export) an electronic sheet 80A-I or clip sheet 70A-I to another file format at the request of User 56A, 56B via their IP networked device 22A, 22B interface module 24A or other application. In an embodiment, a clip sheet processing system 40 may also convert (import) another file format having proper entries to an electronic sheet 80A-I or clip sheet 70A-I at the request of User 56A, 56B via their IP networked device 22A, 22B interface module 24A or other application. A User 56A via a ASCII text processing program may create an importable version of a clip sheet 70A-I, including a text file, spreadsheet file, word processing format file, and database file. The import file may include first attribute (Column) identifiers, second attribute (row) identifiers, text entries, and hyperlinks to folders. A User 56A may use a text processing program to produce an initial file to be used to create a clip sheet 70A-I in an embodiment. In such an embodiment, a clip sheet processing system 40 may add unique identifiers for the first and second identifiers when the import file is converted into an electronic file 80A representing a clip sheet 70A.

A User 56A may also direct the clip sheet processing system 40 to convert a clip sheet 70A-I or related electronic file 80A-I to a format that may be readable by a User's 56A IP networked device's 22A text processing program. A clip sheet processing program 40 may convert a clip sheet first attributes (columns) and second attributes (rows) into columns and rows of a spreadsheet, into columns and rows of a table in a word processing document, and into records with fields of a database. A clip sheet processing program 40 may add ownership information, unique identifiers, or cell location for import purposes into hidden sections of the respective documents. For example, when converting a clip sheet 70A-I or related file 80A-I into a Microsoft® Excel® compatible file, hash values may be added to cells related to ownership, unique identifiers, and cell initial location during export. Such values may enable a clip sheet processing system 40 to import modified exported files back into the exported clip sheet 70A-I or into a new clip sheet 70A-I.

FIG. 1L is a simplified block diagram of multiple files and ASCII text organization and storage architecture 50L with a user device 22A employing an application 23A to view an exported grid structure 170A provided by a clip sheet processing system 40 via an E-mail server 54 according to various embodiments. A user device 22A may also employ an application 23A to create an initial file to be used to create a clip sheet 70A or merge with an existing clip sheet.

A clip sheet processing system 40 may employ the algorithm 150D shown in FIG. 5D to export a clip sheet 70A-I to a User's IP networked device 22A for use by one or more applications. Upon a request from a User to export a clip sheet 70A-I (activity 152D of FIG. 5D, communication 362C of FIG. 2C), a clip sheet processing system 40 may retrieve the clip sheet(s) to be exported to another file format (activity 154D). The clip sheet processing system 40 may have the clip sheet(s) stored locally or request the sheet file 80A-I from a storage system 16 (communications 364C and 366C in FIG. 2C).

A clip sheet processing system 40 may then convert the retrieved clip sheet 70A-I into another application file format or importable format as a function of User's 56A request or system's 40 settings (activity 156D of FIG. 5D). As described above, a clip processing system 40 may include the first attribute (column) and second attribute (row) identifiers, their unique identifiers, text entries, and provide hyperlinks to folders referenced in the clip sheet to be exported. The hyperlinks may provide access to folders 76A-F stored in a directory 76 of a cloud storage system 16 in an embodiment. The clip sheet processing system 40 may then forward the resultant exported format of the clip sheet 70A-I to the User's device 56A electronically including via an E-mail server, file transfer protocol (FTP), or other electronic file transfer mechanism (activity 158D of FIG. 5D and communication 368C of FIG. 2C).

In FIG. 1L, a combined clip sheet 70I may have been converted to a Microsoft Excel importable file format and imported into a Microsoft Excel application 170A. As shown in FIG. 1L, the clip sheet 70I first identifiers (column) identifiers may be imported into the spreadsheet 170A as spreadsheet columns B-H. Row 1 of the spreadsheet may include the first attribute (column) identifiers 172A, 172B from the combined clip sheet 70I. The first column A of the spreadsheet 170A may include the second attribute (row) identifiers of the exported clip sheet 70I from Row 3 to Row 7 for Customer A 174A to Customer E 174B. As shown in FIG. 1L, text entries 78A-C and 78H have been converted to text 178A-C and 178H in the spreadsheet cells.

Clip sheet cell entries representing file(s) or folder(s) 76A-C, 76E, and 76F may be converted to hyperlinks 176A-C, 176E, and 176F. In an embodiment, the hyperlinks may point the file(s) or folder(s) 76A-C, 76E, and 76F in a cloud storage's 16 directory 76. A user 56A may use an exported file processing application to modify items of the exported clip sheet 170A including the first attribute (column) identifiers, second attribute (row) identifiers, and text entries 78A-C and 78H. In an embodiment, the hyperlink entries (to file(s) or folder(s)) may be editable by directing the hyperlink entries to another file, local or in cloud storage. In another embodiment, the hyperlink entries may not be editable or updatable.

A User 56A may direct a clip sheet processing system 40 to import an exported clip sheet file 170A back into a clip sheet file 70I or other importable file type to create a new clip sheet or merged with another clip sheet. A clip sheet processing system 40 may employ the algorithm 150E shown in FIG. 5E to import an electronic file into an existing or new clip sheet. Once a User 56A requests importation of an electronic file to a clip sheet or to update a clip sheet 70I (activity 152E, communication 372C of FIG. 2C), a clip sheet processing program 40 may extract elements or components from the import file for entry into a clip sheet (activity 154E). An import file may include hidden elements that identify or indicate that the file was exported from a clip sheet file. The import file may also include cells indicators another data to enable a clip sheet processing system 40 to combine the extracted components into a pre-existing clip sheet 70I.

The clip sheet processing system 40 may also use hidden exported clip information (including owner and unique identifiers and cell location) to enable a system 40 to map first or second attribute movements (movement of columns or rows) in a clip sheet 70I (activity 156E of FIG. 5E). A clip sheet processing system 40 may also determine whether changes to an existing clip sheet 70A-I includes entries not owned by the importer. A clip sheet processing system 40 may use the procedure discussed above to determine whether the changes should be implemented (approved or rejected by owner(s) or system 40).

Once an external file is imported into a new clip sheet or existing clip sheet 70A-I, a clip sheet processing system 40 may forward the updated or new sheet to the User's 56A IP networked device 22A interface module 24A or other application (activity 158E) as a webpage with the clip sheet or the clip sheet electronic file 80A-I. In an embodiment, a User device 22A, 22B and clip sheet processing system 40 may be part of a larger architecture 50M shown in FIG. 1M. FIG. 1M is a simplified block diagram of multiple files and ASCII text organization and storage architecture 50M with a plurality of user devices including a plurality of IP networked devices 22A to 22B and a plurality of cellular devices 32A to 32B according to various embodiments. Architecture 50M also includes at least one clip sheet processing system 40, at least one cloud storage system 16, a first IP network 10A, a second IP network 10B, and a cellular network 30.

In an embodiment, a User 56A, 56B may employ any of the plurality of IP networked devices 22A to 22B and plurality of cellular devices 32A to 32B to view and process a clip sheet 70A-I provided from a clip sheet processing system 40 via an interface module 24A-24B or 34A-34B for other device 22A-B, 32A-B application. A clip sheet processing system 40 may be able to communicate with a cloud storage system 16 via a first IP network 10A, a plurality of IP networked devices 22A to 22B via another IP network 10B, and a plurality of cellular devices 32A to 32B via a cellular network 30 in an embodiment. As shown in FIG. 1A, a clip sheet processing system 40 may also communicate with a cloud storage system 16 and a plurality of IP networked devices 22A to 22B via a single IP network 10A. In an embodiment, the IP networks 10A and 10B may be coupled. The cellular network 30 may also be coupled via a pathway to an IP network 10A or 10B.

In an embodiment, each user device 22A, 22B, 32A, 32B may include or be provided with an interface module 24A, 24B, 34A, 34B that may enable communication of a clip sheet 70A-I or clip sheet electronic file 80A-I between a user device 22A, 22B, 32A, 32B and a clip sheet processing system 40 server 42 via a network 10A, 10B, 30. An interface module 24A (24B, 34A, 34B not repeated herein for clarity) may be linked or integrated with or executed by a user specific clip sheet manipulation program 54A (FIG. 3A) or an exported clip sheet manipulation program 54B (FIG. 3B).

FIG. 3A is a block diagram of a multiple files and ASCII text organization and storage system 110A with a user device 22A viewing a clip sheet 70B according to various embodiments. FIG. 3B is a block diagram of a multiple files and ASCII text organization and storage system 110B with a user device 22A viewing an exported clip sheet 170A according to various embodiments. In an embodiment, an interface module 24A, 24B may be an extension, update, or add-on specific to a user's clip sheet manipulation program 54A or exported clip sheet manipulation program 54B or generic for several clip sheet manipulation programs 54A or exported clip sheet manipulation programs 54B.

In an embodiment, the clip sheet manipulation program 54A may be a web browser application operable on the user device 22A, 22B, 32A, 32B. The web browser application 54A may be capable of displaying a web page including a web page including the clip sheet display 59A shown in FIG. 3A. In such an embodiment, the interface module 24A may be an extension or add-on specific to a web browser application 54A for viewing and processing a clip sheet 70A-I. Such an interface module 24A may be compiled from various programming packages including Visual Basic, Java, Python, and others. In an embodiment, a clip sheet 70A-I may be embedded in a web page that may be viewed/processed by a standard web browser application and the interface module 24A shown in FIG. 3A may include a network interface or not employed in an embodiment.

In an embodiment, a User's exported clip sheet manipulation program 54B may enable a user 56A, 56B to manipulate an exported clip sheet as shown in FIG. 3B. In such an embodiment, the interface module 24B may be an extension or add-on specific to an exported clip sheet manipulation program 54B. In an embodiment, an exported clip sheet 170A may be processed by a standard user application and the interface module 24B shown in FIG. 3B may not be employed. In an embodiment, an exported clip sheet manipulation program 54B may include a version of Microsoft® Excel®. An interface module 24B may configured as a Microsoft Excel add-on that a User 56A, 56B may install and activate. Such an interface module 24B may be compiled from various programming packages including Visual Basic, Java, Python, and others.

In an embodiment, a User 56A, 56B may receive a link including a link to a HTML file that enables a User 56A, 56B to download an interface module 24A, 24B having a software platform compatible with the User's device 22A and desired clip processing program 54A or exported clip processing program 54B. Selecting a link via a device 22A may cause device information to be embedded in the link including its operating system, e.g., IOS, Linux, Windows, Android, RIM, or other and current version. It is noted that an initial interface module 24A, 24B installation package may be provided by a source other than a clip sheet processing system 40. In an embodiment, the interface module 24A, 24B may be included in a standard or optional add-on or feature of a User's desired or selected clip sheet manipulation program 54 clip processing program 54A or exported clip processing program 54B.

As noted, FIG. 3A is a block diagram of a multiple files and ASCII text organization and storage system 110A with a user device 22A viewing a clip sheet 70B according to various embodiments. As shown in FIG. 3A, the clip sheet processing system 40 may be coupled to a User's 56A IP networked device 22A via an IP network 10A according to various embodiments. A clip sheet processing system 40 may include a server/search engine 42, a clip sheet file formatting module 44, a clip sheet file logic module 46, a user table 49, and a data table or queue 48. As noted, a User's 56A device 22A may include an interface application module 24A as part of a clip sheet manipulation program 54A to receive, process, and communicate clip sheets 70A-I and other data between itself, the clip sheet manipulation program 54A, and a clip sheet processing system 40. The clip sheet manipulation program 54A may provide a User 56A a clip sheet interface 52A as shown in FIG. 3A. The clip sheet interface 52A may include a clip sheet option window 51A and a clip sheet display window 59A in an embodiment.

The clip sheet option window 51A may enable a User 56A to select one or more interface module 24A operations including retrieving or requesting one or more clip sheets, importing a clip sheet, exporting a clip sheet, merging a clip sheet with one or more other clip sheets, tracking clip sheet changes, searching clip sheet(s), and saving/updating clip sheet changes. The clip sheet display window 59A may show a clip sheet 70A-I provided by an interface module 24A via a clip sheet processing system 40 in an embodiment. As shown in FIG. 3A, the clip sheet display window 59A may be a two dimensional construct including rows 53A and first attributes (columns) 57A, second attribute (row) identifiers 74B, first attribute (column) identifiers 72B, and cell 71A entries. The cell entries 71A may include ASCII text entries including entries 78D, 78E, and 78F and digital file(s) or folders including FOLDER D 76D.

In an embodiment, a clip sheet processing system 40 server 42 may generate a clip sheet interface file 25A for processing by an interface module 24A. The clip sheet interface file 25A may include requested clip sheets 70A-I and clip sheet logic related to the clip sheet entries. The clip sheet program logic may include data formatting for the clip sheet manipulation program 54A to show data entry restrictions including text length limits, ability to include multiple entries in a cell 71A, and ability to enter different entry types in a single cell 71A of a clip sheet 70A-70I. The interface module 24A program logic may also include data parameters including ranges or lists of possible values to prevent or help limit keying errors where the program logic may be executed by the interface module 24A or the clip sheet manipulation program 54A. Different Users 56A, 56B or groups may designate desired data formatting or grooming and valid data values. Each user or group preferences and login/registration information may be stored in the User table 49.

Local or active clip sheets 70A-70I, electronic files 80A-80I, clip sheet properties including history and changes, ported (exported and imported) clip sheets 70A-70I, and clip sheet change files 17B (for changes to be approved by one or more Users 56A, 56B) may be stored in the data table 48. The sheet properties may include formatting preferences and valid values or ranges and attributes for local or externally stored clip sheet electronic files 80A-80I and folders 76A-F.

FIG. 3B is a block diagram of a multiple files and ASCII text organization and storage system 110B with a user device 22A viewing an exported clip sheet 170A via a User device text manipulation program 54B according to various embodiments. As noted, a User's 56A exported sheet manipulation program 54B may be any text manipulation program including a word processing, spreadsheet processing, and database processing program. The clip sheet processing program 40 may provide a formatted, exported clip sheet file 25B based on the intended exported manipulation program 54B. The ported sheet file 25B may include program logic in addition to data to provide data grooming, data logic, and grid sheet processing logic in an embodiment.

As shown in FIG. 3B, an exported sheet manipulation program 54B may include Microsoft® Excel®. In such an embodiment, the exported clip sheet interface 52B may be an excel interface with a spreadsheet or workbook sheet acting as an exported sheet display 59B. As shown in FIG. 3B, the spreadsheet 53B or exported clip sheet display may include a first row with clip sheet first attribute (column) identifiers 172A, 172B and second attribute (rows) 174A including the second attribute (row) identifiers and clip sheet cell entries.

As shown in FIG. 3B, the cell entries may include ASCII text entries 178A to 178C and hyperlinks to folder entries 176A and 176F. In an embodiment, the hyperlink entries may be linked to the underlying files or in cloud storage 16 directory 76 or other external storage location. In an embodiment when a cell 71A has multiple folders or file entries 76A-76F in a clip sheet 70A-I, the exported clip sheet cell may be split into a different row (or column) for each folder or file entry 76A-76F as a function of the exported sheet manipulation program's 54B capability of supporting one or more hyperlinks to a file or folder in a cell of table, spreadsheet or database.

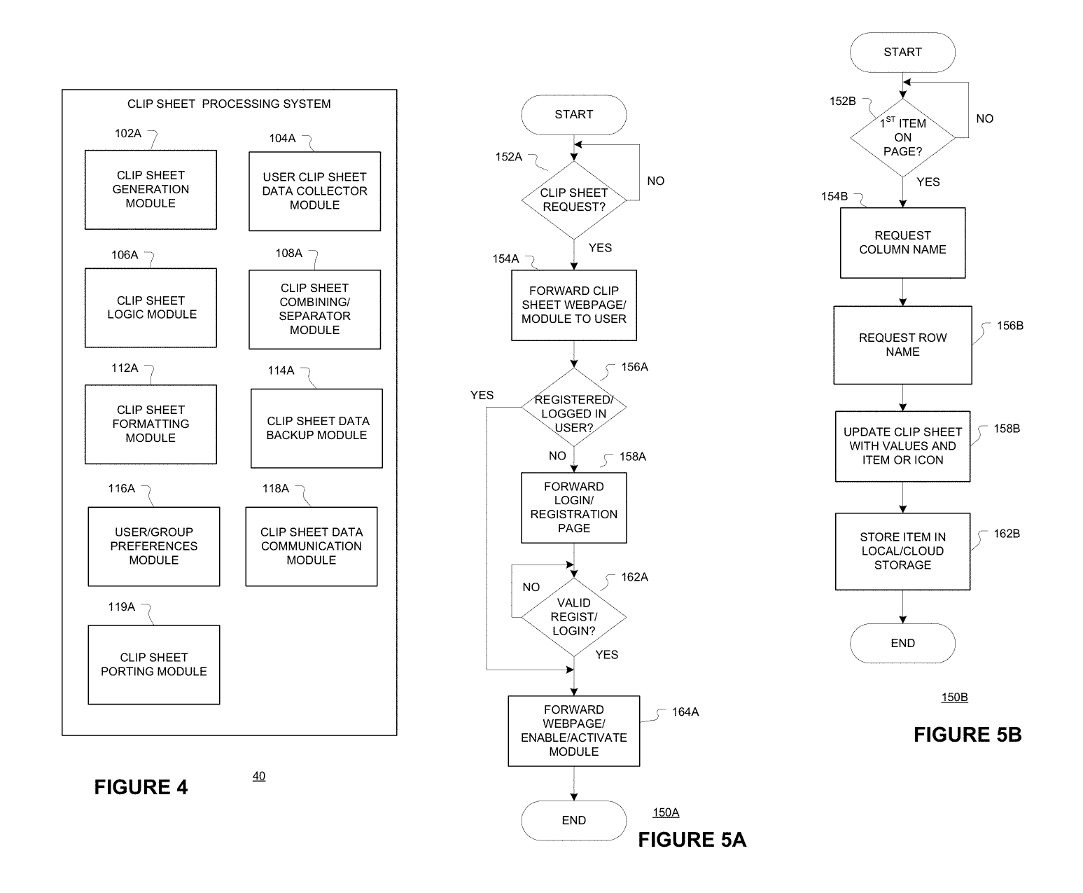

FIG. 4 is a block diagram of modules of a clip sheet processing system 40 according to various embodiments. As shown in FIG. 4, a clip sheet processing system 40 may include several modules including a clip sheet generation module 102A, a user clip sheet collector module 104A, a clip sheet logic generation module 106A, a clip sheet combining/separator module 108A, a clip sheet formatting module 112A, a local clip sheet data backup module 114A, a user and group clip sheet preferences module 116A, a clip sheet data communication module 118A, and a clip sheet porting module 119A.

In an embodiment, a clip sheet generation module 102A may be employed to generate a clip sheet 70A-I from a stored electronic clip sheet file 80A-I or generate a new clip sheet 70A. The generation module 102A may generate different electronic representations of a clip sheet 80A-I based on the User's 56A device 22A, 22B, 32A, 32B and interface modules 24A, 24B, 34A, 34B or User's preferences. For example, the generation module 102A may generate a web browser compatible file including a clip sheet or a version compatible with another display application including a clip sheet specific for a User's processing application or interface module 24A, 24B, 34A, 34B. In an embodiment, the user clip sheet data collector module 104A may store a file, files, or folders inserted into one or more cells. The module 104A may store files or folders 76A-F locally and in an external data storage system including a cloud storage system 16. In an embodiment, the module 104A may assign unique file/folder names to be associated with each file or folder of files 76A-F in clip sheets 70A-70I and may store the files or folders for a clip sheet or multiple clip sheets in a single directory 76.

The clip sheet electronic file 80A-80I may store a unique file or folder name associated with the User provided file or folders 76A-76F. Similarly, the User provided first attribute (column) identifiers 72A, 72B and second attribute (row) identifiers 74A, 74B may be assigned unique identifiers to enable User(s) to assign identical first attribute (column) or second attribute (row) names. In an embodiment, a clip sheet logic generation module 106A may generate program logic to be associated with a clip sheet 70A-70I or exported clip sheet 170A as a function of the selected, detected, or indicated clip sheet manipulation program 54A, 54B. The logic may include macros or other functions that limit data modifications to the clip sheet elements or other functionality. A clip sheet processing system 40 may include valid data parameters for one or more cells or datum including entry of items into cells 71A.

A clip sheet combining/separator module 108A may enable a User 56A, 56B to combine two or more separate clip sheets 70A-70I and separate a clip sheet 70A-70I into two or more sheets. As noted above based on User or system 40 settings when two or more clip sheets are combined, first attributes 72A, second attributes 74A, and cells 71A may be merged. In an embodiment, a User may be able to select one or more segments of a clip sheet 70A-70I to be including in one or more new clip sheets.

The clip sheet formatting module 112A may work with the module 108A and porting module 119A to modify the formatting of clip sheet electronic data to conform to data formatting of an interface module 24A or clip sheet manipulation program 54A, 54B. In another embodiment, the clip sheet formatting module 112A may modify the combined, exported, or imported clip sheet data format(s) to conform with an interface file 25A data format and the interface module 24A.

A clip sheet data backup module 114A may create backups or different instances of modified clip sheets 70A-70I and related files or folders 76A-C. The clip sheet data backup module 114A may enable Users 56A, 56B to retrieve previous versions of clip sheets 70A-70I and related files or folders 76A-C. The backup module 114A may also store clip sheets 70A-70I and related files or folders 76A-C on a User's device 22A, 22B, 32A, 32B or the clip sheet processing system 40.

The user and group preferences module 116A may determine a User's preferences for clip sheet layout, Column merging, Row merging, and cell entry merging, data ranges or valid data values for selected clip sheet attributes that may be employed during clip sheet merging, separation, importing, and exporting. If a User 56A, 56B is associated with one or more groups, the group preferences for clip sheet layout, Column merging, Row merging, and cell entry merging, data ranges or valid data values for selected clip sheet attributes may be employed during clip sheet merging, separation, importing, and exporting.

The data communication module 118A may enable communication of clip sheet 80A-80I and 70A-70I data between a clip sheet processing system 40, a User device 22A, 22B, 32A, 32B, and cloud storage 16. The data communication module 118A may enable bidirectional communication between a clip sheet processing system 40, a User device 22A, 22B, 32A, 32B, and cloud storage 16 including an interface file 25A, which may contain clip sheets 70A-70I, clip sheet electronic files 80A-80I, exported clip sheets 170A, clip sheet logic, formatting rules, annotations, and updates to external and local clip sheets, interface logic, formatting rules, and annotations.

The clip sheet porting module 119A may convert a stored or active clip sheet 70A-I into another format that may be imported into a User's text manipulation program 54B. As noted, a User 56A, 56B, their device 22A, or system 40 may determine how to convert a clip sheet 80A-I electronic file into a format that may be usable or importable by a User's or device's desired manipulation program 54B. A User 56A, 56B, their device 22A, or system 40 may determine how to convert or forward links or actual data for files or folders 76A-F associated with clip sheet(s) to be exported or exported. In an embodiment, the clip sheet porting module 119A may also enable various external file formats to be converted to a clip sheet electronic file 80A-I or other clip sheet 70A-I file format. As noted, an exported clip sheet file may include hidden data including owner information and unique identifiers for first attributes, second attributes, and cell entries.

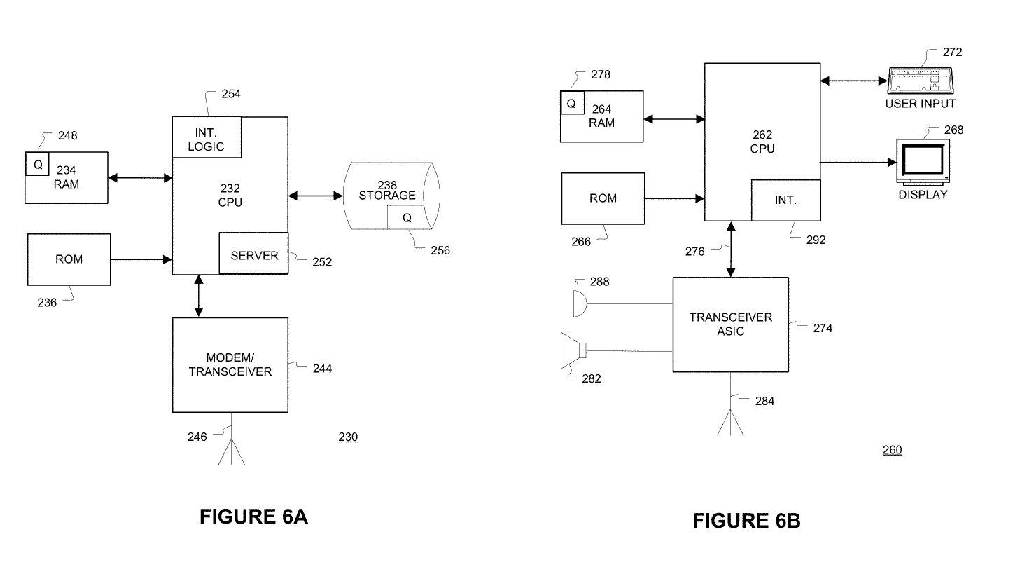

FIG. 6A illustrates a block diagram of a device 230 that may be employed as a clip sheet processing system 40 in various embodiments. The device 230 may include a central processing unit (CPU) 232, a random access memory (RAM) 234, a read only memory (ROM) 236, a storage unit 238, a modem/transceiver 244, and an antenna 246. The CPU 232 may include a server/search engine module 252 and an interface logic/interface formatting module 254. The RAM 234 may include a queue or table 248 where the queue 248 may be used to store the user table 49 and data 48. The storage 238 may also include a queue or database 256 where the queue 256 may be used to store the user table 49 and data 48. The storage 238 may be local or coupled to the device 230 via one or more networks 10A, 10B, 30 including the cloud storage 16. The server/search engine module 252 and the interface logic/interface formatting module 254 may be separate elements.

The modem/transceiver 244 may couple, in a well-known manner, the device 230 to the IP networks 10A, 10B and cellular network 30 to enable communication with the devices 16, 22A, 22B, 32A, and 32B. In an embodiment, the modem/transceiver 244 may be a wireless modem or other communication device that may enable communication with the devices 16, 22A, 22B, 32A, and 32B. The CPU 232 via the server module 252 may direct communication between modem 244 and a device 16, 22A, 22B, 32A, and 32B.

The ROM 236 may store program instructions to be executed by the CPU 232, interface logic/interface formatting module 254, or server module 252. The RAM 234 may be used to store temporary program information, queues, databases, and overhead information. The storage device 238 may comprise any convenient form of data storage and may be used to store temporary program information, clip sheets, queues, databases, and overhead information.

A device 260 is shown in FIG. 6B that may be used in various embodiments as a device 16, 22A, 22B, 32A, and 32B. The device 260 may include a central processing unit (CPU) 262, a random access memory (RAM) 264, a read only memory (ROM″) 266, a display 268, a user input device 272, a transceiver application specific integrated circuit (ASIC) 274, a microphone 288, a speaker 282, and an antenna 284. The CPU 262 may include an interface module 292. The RAM 264 may include a queue 278 where the queue 278 may store DCS datum and changes in track mode. The interface module 292 may process interface files 25A from and generate change data requests for the clip sheet processing system 40.

The ROM 266 is coupled to the CPU 262 and may store the program instructions to be executed by the CPU 262, a User's 56A, 56B non-exported or exported clip sheet manipulation program 54A, 54B, and the interface module 292. The RAM 264 is coupled to the CPU 262 and may store temporary program data, overhead information, change data, local clip sheet data, and the queues 278. The user input device 272 may comprise an input device such as a keypad, touch pad screen, track ball or other similar input device that allows the user to navigate through menus in order to operate the device 260. The display 268 may be an output device such as a CRT, LCD or other similar screen display that enables the user to read, view, or hear received external and local data from the clip sheet processing system 40.

The microphone 288 and speaker 282 may be incorporated into the device 260. The microphone 288 and speaker 282 may also be separated from the device 260. Received data may be transmitted to the CPU 262 via a serial bus 276 where the data may include external and local clip sheet data, interface files 25A, or protocol information. The transceiver ASIC 274 may include an instruction set necessary to communicate messages, clip sheet data, media or pages in architecture 50A-M, 110A, 110B (for the IP network 16 or cellular network 30). The ASIC 274 may be coupled to the antenna 284 to communicate wireless messages, interface files 25A, and other communications within the architecture 50A-M, 110A, 110B. When a message is received by the transceiver ASIC 274, its corresponding data may be transferred to the CPU 262 via the serial bus 276. The data can include wireless protocol, overhead information, interface files 25A, and other communications to be processed by the device 260 in accordance with the methods described herein.

Any of the components previously described can be implemented in a number of ways, including embodiments in software. Any of the components previously described can be implemented in a number of ways, including embodiments in software. Thus, the CPU 232, an interface logic/interface formatting module 254, server module 252, modem/transceiver 244, antenna 246, storage 238, RAM 234, ROM 236, queue 248, queue 256, CPU 262, interface 292, transceiver ASIC 274, antenna 284, microphone 288, speaker 282, ROM 266, RAM 264, queue 278, user input 272, display 268, may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A computer-implemented method comprising:
providing a two-dimensional grid structure including a plurality of columns and a plurality of rows, and a cell at the intersection of each column and each row for editing in real time;
enabling a user to enter one of text, a file, or a folder of files into a cell at the intersection of one of the plurality of columns and one of the plurality of rows when one of the cell does not include an entry and the cell including a similar entry;
requesting a user to provide a first attribute identifier for the column of the plurality of columns intersecting the cell when a first attribute identifier has not been provided by a user and assigning a unique identifier for the first attribute;
requesting a user to provide a second attribute identifier for the row of the plurality of rows intersecting the cell when a first attribute identifier has not been provided by a user and assigning a unique identifier for the second attribute;
storing the text based cell entries, the first attribute identifiers and associated unique identifiers, and the second attribute identifiers and associated unique identifiers in a single file in networked based storage; and
storing the file and folder based cell entries in networked based storage.

2. The computer-implemented method of claim 1, further comprising including a User identifier for each cell entry and provided first attribute identifier and second attribute identifier.

3. The computer-implemented method of claim 1, further comprising providing the two-dimensional grid structure in web page.

4. The computer-implemented method of claim 1, further comprising storing the file and folder based cell entries in cloud based storage.

5. The computer-implemented method of claim 1, further comprising storing all file and folder based cell entries in a grid structure in a single directory of cloud based storage.

6. The computer-implemented method of claim 1, further comprising creating a unique identifier for each file and folder based cell entry in a grid structure and storing all file and folder based cell entries in a grid structure in a single directory of cloud based storage via the unique identifiers.

7. The computer-implemented method of claim 6, further comprising storing the text based cell entries, the first attribute identifiers and associated unique identifiers, the second attribute identifiers and associated unique identifiers, and pathways to each file and folder based cell entry in a grid structure in a single directory of cloud based storage via the unique identifiers in a single file in cloud based storage.

8. The computer-implemented method of claim 1, further including enabling a first User to merge a section of the first User's grid structure with a section of a second User's grid structure.

9. The computer-implemented method of claim 8, further including merging a section of the first grid structure with a section of a second grid structure based on their respective first and second attribute identifiers.

10. The computer-implemented method of claim 8, further including merging a section of the first grid structure with a section of a second grid structure based on their respective first and second attribute identifiers and their cell entries.

11. A two-dimensional grid processing system comprising:
a grid generation module, the module:
providing a two-dimensional grid structure including a plurality of columns and a plurality of rows, and a cell at the intersection of each column and each row for editing in real time;
enabling a user to enter one of text, a file, or a folder of files into a cell at the intersection of one of the plurality of columns and one of the plurality of rows when one of the cell does not include an entry and the cell including a similar entry;
requesting a user to provide a first attribute identifier for the column of the plurality of columns intersecting the cell when a first attribute identifier has not been provided by a user and assigning a unique identifier for the first attribute; and
requesting a user to provide a second attribute identifier for the row of the plurality of rows intersecting the cell when a first attribute identifier has not been provided by a user and assigning a unique identifier for the second attribute; and
a clip sheet communication module, the module:
storing the text based cell entries, the first attribute identifiers and associated unique identifiers, and the second attribute identifiers and associated unique identifiers in a single file in networked based storage; and
storing the file and folder based cell entries in networked based storage.

12. The two-dimensional grid processing system of claim 11, further comprising including a User identifier for each cell entry and provided first attribute identifier and second attribute identifier.

13. The two-dimensional grid processing system of claim 11, further comprising the grid generation module providing the two-dimensional grid structure in web page.

14. The two-dimensional grid processing system of claim 11, further comprising the clip sheet communication module storing the file and folder based cell entries in cloud based storage.

15. The two-dimensional grid processing system of claim 11, further comprising the clip sheet communication module storing all file and folder based cell entries in a grid structure in a single directory of cloud based storage.

16. The two-dimensional grid processing system of claim 11, further comprising the grid generation module creating a unique identifier for each file and folder based cell entry in a grid structure and the clip sheet communication module storing all file and folder based cell entries in a grid structure in a single directory of cloud based storage via the unique identifiers.

17. The two-dimensional grid processing system of claim 18, further comprising the clip sheet communication module storing the text based cell entries, the first attribute identifiers and associated unique identifiers, the second attribute identifiers and associated unique identifiers, and pathways to each file and folder based cell entry in a grid structure in a single directory of cloud based storage via the unique identifiers in a single file in cloud based storage.

18. The two-dimensional grid processing system of claim 11, further including a grid structure merging module, the module enabling a first User to merge a section of the first User's grid structure with a section of a second User's grid structure.

19. The two-dimensional grid processing system of claim 18, further including the grid structure merging module merging a section of the first grid structure with a section of a second grid structure based on their respective first and second attribute identifiers.

20. The two-dimensional grid processing system of claim 18, further including the grid structure merging module merging a section of the first grid structure with a section of a second grid structure based on their respective first and second attribute identifiers and their cell entries.
